(19) United States
(12) Patent Application Publication
(10) Pub. No.: US 2026/0058742 A1
(43) Pub. Date: Feb. 26, 2026

(54) CROSS-LINK INTERFERENCE TIMING ALIGNMENT FOR PARTIAL TIMING ADVANCE

(71) Applicant: QUALCOMM INCORPORATED, San Diego, CA (US)

(72) Inventors: Yuwei REN, Beijing (CN); Huilin XU, Temecula, CA (US); Yan ZHOU, San Diego, CA (US); Qian ZHANG, Basking Ridge, NJ (US)

(21) Appl. No.: 19/101,891

(22) PCT Filed: Sep. 20, 2022
(86) PCT No.: PCT/CN2022/119789

§ 371 Date: Feb. 6, 2025

(51) Int. Cl. H04B 17/345; H04W 56/00

(52) U.S. Cl. CPC H04B 17/345; H04W 56/0045

(57) ABSTRACT

Methods, systems, and devices for wireless communications are described. A user equipment (UE) may receive an indication of one or more timing advance (TA) parameters to apply for receiving one or more downlink messages and for receiving reference signals associated with one or more cross-link interference (CLI) measurements. The UE may receive the one or more downlink messages by applying a first TA parameter of the one or more TA parameters during a first data reception occasion. The UE may then apply either the first TA parameter or a second TA parameter of the one or more TA parameters to receive one or more reference signals during a CLI measurement occasion. The UE may perform one or more CLI measurements based on the application of the one or more TA parameters during the CLI measurement occasion.

### CROSS REFERENCE

The application is a 371 National Stage of PCT Application No. PCT/CN2022/119789, filed on Sep. 20, 2022, entitled “CROSS-LINK INTERFERENCE TIMING ALIGNMENT FOR PARTIAL TIMING ADVANCE,” and assigned to the assignee hereof. The disclosure of the prior Application is considered part of and is incorporated by reference into this Patent Application.

### FIELD OF TECHNOLOGY

The following relates to wireless communications, including cross-link interference (CLI) timing alignment for partial timing advance (TA).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support cross-link interference (CLI) timing alignment for partial timing advance (TA). For example, the described techniques enable a user equipment (UE) to maintain one or more TA parameters to apply for receiving and transmitting data, and to enable the UE to perform CLI measurements. In some cases, the UE may experience increased timing misalignment between communication symbols as a result of full-duplexing capabilities and partial TA capabilities. For instance, the UE may receive an indication of one or more TA parameters, and may use a first TA parameter to apply for receiving one or more downlink messages and to apply for receiving one or more reference signals for performing one or more CLI measurements. In some other examples, the UE may receive two different TA values, and may apply a first TA value for receiving one or more downlink messages and may use a second TA value (e.g., different from the first TA value) to apply for receiving the one or more reference signals for performing the one or more CLI measurements.

A method for wireless communication at a wireless device is described. The method may include receiving an indication of a first TA parameter to apply for receiving one or more downlink messages and a second TA parameter to apply for receiving one or more reference signals associated with one or more CLI measurements, receiving the one or more downlink messages based on applying the first TA parameter during a first data reception occasion, and performing the one or more CLI measurements based on applying the second TA parameter to receive the one or more reference signals during a CLI measurement occasion.

An apparatus for wireless communication at a wireless device is described. The apparatus may include a processor, memory coupled with the processor, and instructions stored in the memory. The instructions may be executable by the processor to cause the apparatus to receive an indication of a first TA parameter to apply for receiving one or more downlink messages and a second TA parameter to apply for receiving one or more reference signals associated with one or more CLI measurements, receive the one or more downlink messages based on applying the first TA parameter during a first data reception occasion, and perform the one or more CLI measurements based on applying the second TA parameter to receive the one or more reference signals during a CLI measurement occasion.

Another apparatus for wireless communication at a wireless device is described. The apparatus may include means for receiving an indication of a first TA parameter to apply for receiving one or more downlink messages and a second TA parameter to apply for receiving one or more reference signals associated with one or more CLI measurements, means for receiving the one or more downlink messages based on applying the first TA parameter during a first data reception occasion, and means for performing the one or more CLI measurements based on applying the second TA parameter to receive the one or more reference signals during a CLI measurement occasion.

A non-transitory computer-readable medium storing code for wireless communication at a wireless device is described. The code may include instructions executable by a processor to receive an indication of a first TA parameter to apply for receiving one or more downlink messages and a second TA parameter to apply for receiving one or more reference signals associated with one or more CLI measurements, receive the one or more downlink messages based on applying the first TA parameter during a first data reception occasion, and perform the one or more CLI measurements based on applying the second TA parameter to receive the one or more reference signals during a CLI measurement occasion.

In some examples of the method, apparatuses, and non-transitory computer-readable medium described herein, the first TA parameter may be associated with a first TA coefficient and the second TA parameter may be associated with a second TA coefficient and the method, apparatuses, and non-transitory computer-readable medium may include further operations, features, means, or instructions for switching between applying the first TA coefficient to the first TA parameter during the first data reception occasion and the second TA coefficient to the second TA parameter during the CLI measurement occasion.

Some examples of the method, apparatuses, and non-transitory computer-readable medium described herein may further include operations, features, means, or instructions for receiving the one or more downlink messages based on applying the first TA coefficient and performing the one or more CLI measurements based on applying the second TA coefficient, where the first TA parameter may be different from the second TA parameter based on the first TA coefficient, the second TA coefficient, or both.

Some examples of the method, apparatuses, and non-transitory computer-readable medium described herein may further include operations, features, means, or instructions for receiving, prior to the CLI measurement occasion, a downlink control message including an indication of the second TA parameter and performing the one or more CLI measurements based on the indication of the second TA parameter.

In some examples of the method, apparatuses, and non-transitory computer-readable medium described herein, the indication of the second TA parameter instructs the wireless device to switch between applying the first TA parameter during the first data reception occasion and applying the second TA parameter during the CLI measurement occasion.

In some examples of the method, apparatuses, and non-transitory computer-readable medium described herein, the indication of the second TA parameter indicates a value of the first TA parameter, the second TA parameter, or both.

In some examples of the method, apparatuses, and non-transitory computer-readable medium described herein, the first TA parameter includes a full TA value and the second TA parameter includes a partial TA value and the method, apparatuses, and non-transitory computer-readable medium may include further operations, features, means, or instructions for receiving the one or more downlink messages based on applying the full TA value and performing the one or more CLI measurements based on applying the partial TA value.

In some examples of the method, apparatuses, and non-transitory computer-readable medium described herein, the second TA parameter may be based on the first TA parameter and a difference between the first TA parameter and the second TA parameter may be less than a threshold timing offset.

In some examples of the method, apparatuses, and non-transitory computer-readable medium described herein, the wireless device is a first wireless device, a misalignment occurs between an uplink transmission of a second wireless device and the CLI measurement occasion and the method, apparatuses, and non-transitory computer-readable medium may include further operations, features, means, or instructions for applying the first TA parameter and the second TA parameter based on prioritizing reception of the one or more downlink messages over performing the one or more CLI measurements.

In some examples of the method, apparatuses, and non-transitory computer-readable medium described herein, the first TA parameter and the second TA parameter include full TA parameters, partial TA parameters, or a combination thereof.

A method for wireless communication at a wireless device is described. The method may include receiving an indication of a TA parameter to apply for receiving one or more downlink messages and to apply for receiving one or more reference signals associated with one or more CLI measurements, receiving the one or more downlink messages based on applying the TA parameter during a data reception occasion, and performing the one or more CLI measurements based on applying the TA parameter to receive the one or more reference signals during a CLI measurement occasion.

An apparatus for wireless communication at a wireless device is described. The apparatus may include a processor, memory coupled with the processor, and instructions stored in the memory. The instructions may be executable by the processor to cause the apparatus to receive an indication of a TA parameter to apply for receiving one or more downlink messages and to apply for receiving one or more reference signals associated with one or more CLI measurements, receive the one or more downlink messages based on applying the TA parameter during a data reception occasion, and perform the one or more CLI measurements based on applying the TA parameter to receive the one or more reference signals during a CLI measurement occasion.

Another apparatus for wireless communication at a wireless device is described. The apparatus may include means for receiving an indication of a TA parameter to apply for receiving one or more downlink messages and to apply for receiving one or more reference signals associated with one or more CLI measurements, means for receiving the one or more downlink messages based on applying the TA parameter during a data reception occasion, and means for performing the one or more CLI measurements based on applying the TA parameter to receive the one or more reference signals during a CLI measurement occasion.

A non-transitory computer-readable medium storing code for wireless communication at a wireless device is described. The code may include instructions executable by a processor to receive an indication of a TA parameter to apply for receiving one or more downlink messages and to apply for receiving one or more reference signals associated with one or more CLI measurements, receive the one or more downlink messages based on applying the TA parameter during a data reception occasion, and perform the one or more CLI measurements based on applying the TA parameter to receive the one or more reference signals during a CLI measurement occasion.

Some examples of the method, apparatuses, and non-transitory computer-readable medium described herein may further include operations, features, means, or instructions for receiving the indication of the TA parameter as a downlink control message, the downlink control message indicating a value of the TA parameter.

Some examples of the method, apparatuses, and non-transitory computer-readable medium described herein may further include operations, features, means, or instructions for receiving the indication of the TA parameter, where a value of the TA parameter may be determined based on the indication of the TA parameter.

Some examples of the method, apparatuses, and non-transitory computer-readable medium described herein may further include operations, features, means, or instructions for receiving a CLI measurement configuration that indicates one or more CLI measurement resources to use for performing the one or more CLI measurements, where the CLI measurement configuration further indicates whether the TA parameter may be applied to the one or more CLI measurement resources.

In some examples of the method, apparatuses, and non-transitory computer-readable medium described herein, the TA parameter may be associated with a partial TA value or a full TA value.

Some examples of the method, apparatuses, and non-transitory computer-readable medium described herein may further include operations, features, means, or instructions for receiving a CLI measurement configuration that indicates a partial TA value and applying the TA parameter during the data reception occasion, the CLI measurement occasion, or both, based on the partial TA value.

Some examples of the method, apparatuses, and non-transitory computer-readable medium described herein may further include operations, features, means, or instructions for receiving a CLI measurement configuration that includes a TA coefficient, where the TA coefficient may be associated with one or more CLI measurement resources for performing the one or more CLI measurements.

Some examples of the method, apparatuses, and non-transitory computer-readable medium described herein may further include operations, features, means, or instructions for receiving, in a downlink message separate from a CLI measurement configuration, a TA coefficient that may be associated with one or more CLI measurement resources for performing the one or more CLI measurements.

In some examples of the method, apparatuses, and non-transitory computer-readable medium described herein, the wireless device is a first wireless device, a value of the TA parameter may be associated with a timing difference between the CLI measurement occasion and an uplink transmission of a second wireless device, and the method, apparatuses, and non-transitory computer-readable medium may include further operations, features, means, or instructions for applying the value of the TA parameter such that the timing difference between the CLI measurement occasion and the uplink transmission may be less than a threshold time difference.

Some examples of the method, apparatuses, and non-transitory computer-readable medium described herein may further include operations, features, means, or instructions for receiving an indication of a partial TA coefficient applied by a second wireless device, where a value of the TA parameter may be based on application of the partial TA coefficient to the TA parameter.

In some examples of the method, apparatuses, and non-transitory computer-readable medium described herein, the TA parameter may be based on a second TA parameter associated with a second wireless device and a difference between the TA parameter and the second TA parameter may be less than a threshold timing offset.

Some examples of the method, apparatuses, and non-transitory computer-readable medium described herein may further include operations, features, means, or instructions for switching from a full-duplex mode to a half-duplex mode based on a determined misalignment between the CLI measurement occasion and a corresponding uplink transmission of a second wireless device and performing the one or more CLI measurements based on applying the TA parameter and switching from the full-duplex mode to the half-duplex mode.

In some examples of the method, apparatuses, and non-transitory computer-readable medium described herein, the wireless device is a first wireless device, a misalignment occurs between an uplink transmission of a second wireless device and the CLI measurement occasion and the method, apparatuses, and non-transitory computer-readable medium may include further operations, features, means, or instructions for applying the TA parameter based on prioritizing reception of the one or more downlink messages over performing the one or more CLI measurements.

In some examples of the method, apparatuses, and non-transitory computer-readable medium described herein, the TA parameter includes a full TA parameter or a partial TA parameters.

A method for wireless communication at a network entity is described. The method may include transmitting an indication of a first TA parameter associated with one or more downlink messages and a second TA parameter associated with one or more reference signals corresponding to one or more CLI measurements, transmitting the one or more downlink messages during a first data reception occasion, transmitting the one or more reference signals during a CLI measurement occasion, and receiving the one or more CLI measurements based on the first TA parameter and the second TA parameter.

An apparatus for wireless communication at a network entity is described. The apparatus may include a processor, memory coupled with the processor, and instructions stored in the memory. The instructions may be executable by the processor to cause the apparatus to transmit an indication of a first TA parameter associated with one or more downlink messages and a second TA parameter associated with one or more reference signals corresponding to one or more CLI measurements, transmit the one or more downlink messages during a first data reception occasion, transmit the one or more reference signals during a CLI measurement occasion, and receive the one or more CLI measurements based on the first TA parameter and the second TA parameter.

Another apparatus for wireless communication at a network entity is described. The apparatus may include means for transmitting an indication of a first TA parameter associated with one or more downlink messages and a second TA parameter associated with one or more reference signals corresponding to one or more CLI measurements, means for transmitting the one or more downlink messages during a first data reception occasion, means for transmitting the one or more reference signals during a CLI measurement occasion, and means for receiving the one or more CLI measurements based on the first TA parameter and the second TA parameter.

A non-transitory computer-readable medium storing code for wireless communication at a network entity is described. The code may include instructions executable by a processor to transmit an indication of a first TA parameter associated with one or more downlink messages and a second TA parameter associated with one or more reference signals corresponding to one or more CLI measurements, transmit the one or more downlink messages during a first data reception occasion, transmit the one or more reference signals during a CLI measurement occasion, and receive the one or more CLI measurements based on the first TA parameter and the second TA parameter.

Some examples of the method, apparatuses, and non-transitory computer-readable medium described herein may further include operations, features, means, or instructions for transmitting, prior to the CLI measurement occasion, a downlink control message including an indication of the second TA parameter and receiving the one or more CLI measurements based on the indication of the second TA parameter.

In some examples of the method, apparatuses, and non-transitory computer-readable medium described herein, the first TA parameter includes a full TA value and the second TA parameter includes a partial TA value and the method, apparatuses, and non-transitory computer-readable medium may include further operations, features, means, or instructions for transmitting the one or more downlink messages based on the full TA value and receiving the one or more CLI measurements based on the partial TA value.

A method for wireless communication at a network entity is described. The method may include transmitting an indication of a TA parameter associated with one or more downlink messages and associated with one or more reference signals corresponding to one or more CLI measurements, transmitting the one or more downlink messages during a data reception occasion, transmitting the one or more reference signals during a CLI measurement occasion, and receiving the one or more CLI measurements based on the TA parameter.

An apparatus for wireless communication at a network entity is described. The apparatus may include a processor, memory coupled with the processor, and instructions stored in the memory. The instructions may be executable by the processor to cause the apparatus to transmit an indication of a TA parameter associated with one or more downlink messages and associated with one or more reference signals corresponding to one or more CLI measurements, transmit the one or more downlink messages during a data reception occasion, transmit the one or more reference signals during a CLI measurement occasion, and receive the one or more CLI measurements based on the TA parameter.

Another apparatus for wireless communication at a network entity is described. The apparatus may include means for transmitting an indication of a TA parameter associated with one or more downlink messages and associated with one or more reference signals corresponding to one or more CLI measurements, means for transmitting the one or more downlink messages during a data reception occasion, means for transmitting the one or more reference signals during a CLI measurement occasion, and means for receiving the one or more CLI measurements based on the TA parameter.

A non-transitory computer-readable medium storing code for wireless communication at a network entity is described. The code may include instructions executable by a processor to transmit an indication of a TA parameter associated with one or more downlink messages and associated with one or more reference signals corresponding to one or more CLI measurements, transmit the one or more downlink messages during a data reception occasion, transmit the one or more reference signals during a CLI measurement occasion, and receive the one or more CLI measurements based on the TA parameter.

Some examples of the method, apparatuses, and non-transitory computer-readable medium described herein may further include operations, features, means, or instructions for transmitting a downlink control message including an indication of a value of the TA parameter.

Some examples of the method, apparatuses, and non-transitory computer-readable medium described herein may further include operations, features, means, or instructions for transmitting a CLI measurement configuration that indicates one or more CLI measurement resources corresponding to the one or more CLI measurements, where the CLI measurement configuration further indicates whether the TA parameter may be applied to the one or more CLI measurement resources.

### BRIEF DESCRIPTION OF THE DRAWINGS

FIGS. 1 and 2 illustrate examples of wireless communications systems that support cross-link interference (CLI) timing alignment for partial timing advance (TA) in accordance with one or more aspects of the present disclosure.

FIG. 3 illustrates examples of TA signaling alignment configurations that support CLI timing alignment for partial TA in accordance with one or more aspects of the present disclosure.

FIG. 4 illustrates an example of a TA switching configuration that supports CLI timing alignment for partial TA in accordance with one or more aspects of the present disclosure.

FIG. 5 illustrates an example of TA signaling alignment configurations that support CLI timing alignment for partial TA in accordance with one or more aspects of the present disclosure.

FIG. 6 illustrates an example of process flow that supports CLI timing alignment for partial TA in accordance with one or more aspects of the present disclosure.

FIGS. 7 and 8 show block diagrams of devices that support CLI timing alignment for partial TA in accordance with one or more aspects of the present disclosure.

FIG. 9 shows a block diagram of a communications manager that supports CLI timing alignment for partial TA in accordance with one or more aspects of the present disclosure.

FIG. 10 shows a diagram of a system including a device that supports CLI timing alignment for partial TA in accordance with one or more aspects of the present disclosure.

FIGS. 11 and 12 show block diagrams of devices that support CLI timing alignment for partial TA in accordance with one or more aspects of the present disclosure.

FIG. 13 shows a block diagram of a communications manager that supports CLI timing alignment for partial TA in accordance with one or more aspects of the present disclosure.

FIG. 14 shows a diagram of a system including a device that supports CLI timing alignment for partial TA in accordance with one or more aspects of the present disclosure.

FIGS. 15 through 21 show flowcharts illustrating methods that support CLI timing alignment for partial TA in accordance with one or more aspects of the present disclosure.

### DETAILED DESCRIPTION

Some wireless communications systems may support simultaneous communications between user equipment (UE) and one or more network entities using different resources for uplink and downlink communications. For example, devices (e.g., UEs, network entities) may communicate using different frequency resources, different time resources, or a combination thereof. In some cases, devices may experience signaling interference such as cross-link interference (CLI), where the devices interfere with one another while performing wireless communications.

To account for timing misalignments that may occur between uplink and downlink symbols due to CLI, the UE may apply a constant timing offset of a timing advance (TA) to reduce possible performance challenges due to the timing misalignment. In some cases, however, application of a full TA while a device is operating in a full-duplex mode may lead to increased misalignment due to a loss of orthogonality between the uplink and downlink symbols. In such cases, a UE may apply a partial TA which may granularly adjust the timing of uplink and downlink symbols to increase alignment.

The UE may perform CLI measurements to determine the relative strength of the CLI, to determine a TA or partial TA to apply for aligning uplink and downlink communications, or to reduce signaling interference. In some examples, however, devices may support different combinations of duplexing capabilities and TA application capabilities, which may increase complexity and reduce CLI measurement performance.

To mitigate the effects of timing misalignments, a UE may be capable of maintaining two separate TAs, and may switch between TAs for different settings. For example, a UE may apply a first TA for receiving downlink data during a downlink reception occasion, and may apply a second TA for receiving reference signaling for performing CLI measurements during a CLI measurement occasion. The UE may receive control signaling such as downlink control information (DCI) that may indicate the different TA values or whether the UE is capable of switching between two TA values. In some other examples, a UEs may be capable of maintaining a single TA value that may support accurate downlink reception and CLI measurement. The UE may determine various coefficients to apply to an existing TA value to support more effective alignment, or the UEs may receive control signaling to determine various TA values to apply.

Aspects of the disclosure are initially described in the context of wireless communications systems. Aspects of the disclosure are further illustrated by and described with reference to TA signaling alignment configurations, TA switching configurations, a process flow, apparatus diagrams, system diagrams, and flowcharts that relate to CLI timing alignment for partial TA.

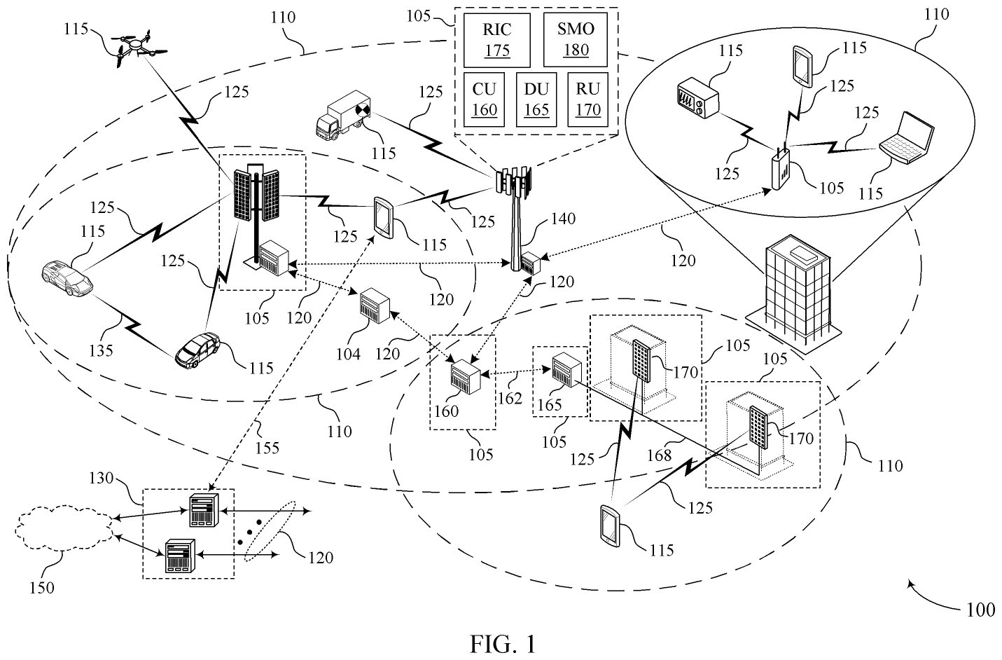

FIG. 1 illustrates an example of a wireless communications system 100 that supports CLI timing alignment for partial TA in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support CLI timing alignment for partial TA as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

Wireless communications system 100 may support simultaneous communications between UE 115 and network entities 105 using uplink, downlink, and sidelink communications. For example, devices may communicate using different frequency resources, different time resources, or a combination thereof. In some such cases, devices may experience CLI where the devices interfere with one another while performing wireless communications, such as when communicating in the same or overlapping frequency bands, in frequency ranges within a given frequency range, or in frequency ranges or bands associated with an integer multiple of a given frequency. In addition, some devices may be capable of full-duplex communications to increase overall signaling capacity of the wireless communications system 100. To account for timing misalignments that may occur between uplink and downlink symbols due to CLI, a UE 115 may apply a constant timing offset or a TA to reduce possible timing misalignments. In some cases, however, application of a full TA while operating in a full-duplex mode may lead to increased misalignment due to a loss of orthogonality between the uplink and downlink symbols. In such cases, the UE may apply a partial TA which may granularly adjust the timing of uplink and downlink symbols to increase alignment.

The UE 115 may perform CLI measurements to determine the relative strength of the CLI, to determine a TA or partial TA to apply for aligning uplink and downlink communications, or to reduce signaling interference. In some examples, however, devices may support different combinations of duplexing capabilities and TA application capabilities, which may increase complexity and reduce CLI measurement performance. Thus, to mitigate or reduce the effects of timing misalignments, the UE 115 may be capable of maintaining two separate TAs, and may switch between TAs for different communication scenarios or operations. For example, the UE 115 may apply a first TA for receiving downlink data during a downlink reception occasion, and may apply a second TA for receiving reference signaling for performing CLI measurements during a CLI measurement occasion. In some other examples, the UE 115 may be capable of maintaining a single TA value that may support accurate downlink reception and CLI measurement.

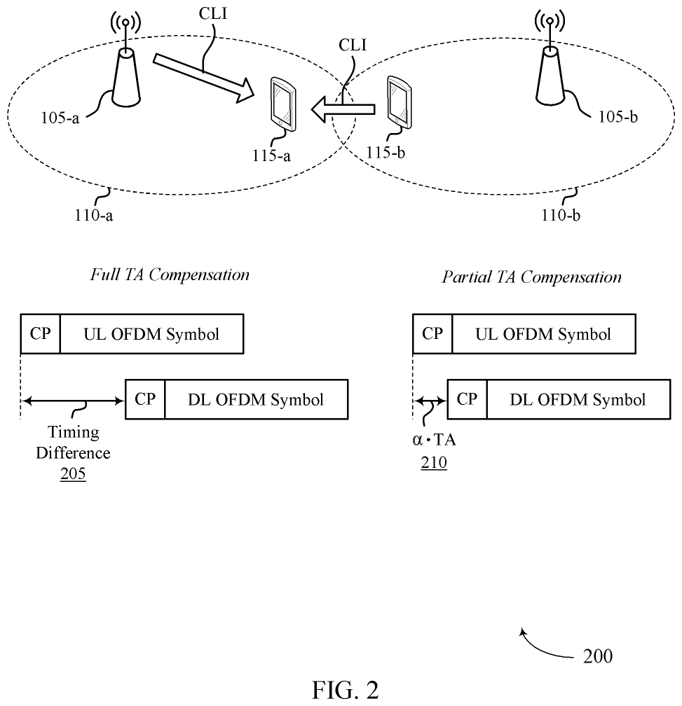

FIG. 2 illustrates an example of a wireless communications system 200 that supports CLI timing alignment for partial TA in accordance with one or more aspects of the present disclosure. In some examples, wireless communications system 200 may implement aspects of wireless communications system 100. The wireless communications system 200 may include UE 115-a and UE 115-b, which may each be examples of UEs 115 as described herein. The wireless communications system 200 may also include a network entity 105-a and a network entity 105-b, which may each be examples of network entities 105 described herein. The network entities 105 may each be associated with a cell that provides wireless communications within a coverage area 110. For example, the network entity 105-a may provide a cell within coverage area 110-a, and the network entity 105-b may provide a cell within coverage area 110-b.

Wireless communications system 200 may support simultaneous communications between UE 115-a and network entity 105-a and UE 115-b and network entity 105-b using different resources for uplink and downlink communications. For example, devices may communicate using different frequency resources using frequency division duplexing (FDD), different time resources using time division duplexing (TDD), or a combination thereof. While FDD systems support both uplink and downlink frequency bands, TDD networks may utilize the same bandwidth, but allocate different time slots for uplink and downlink communications. In some such cases, the wireless communications system 200 may experience signaling interference such as CLI, where the devices interfere with one another as they transmit and receive in the same frequency band.

The UE 115-a or the UE 115-b may perform CLI measurements to determine the relative strength of the CLI, to determine a TA to apply for aligning uplink and downlink communications, and to reduce signaling interference. In some examples, however, CLI may be obtained from other UE transmissions, for example, the UE 115-b may be an “aggressor” UE which causes increased CLI for the UE 115-a (e.g., a “victim” UE). In such cases, the UE 115-a may use a different downlink reception timing for performing CLI measurements (e.g., rather than a default downlink reception timing).

When the UE 115-a measures sounding reference signal-reference signal receive power (SRS-RSRP) and CLI-reference signal strength indicator (CLI-RSSI) values, the UE 115-a may apply a constant offset relative to the downlink reference timing in the coverage area 110-a. This constant offset value may be derived by UE implementation and may be the same or greater than a configured threshold offset.

In wireless communications system 200, CLI may occur among the adjacent UEs (e.g., cell-edge UE 115-a and UE 115-b) within the coverage area 110-a and the coverage area 110-b (e.g., wireless cells) of similar size, which may introduce limited propagation delay, and the CLI measurement timing may be aligned with the uplink transmission timing of the aggressor UE 115-b. For intra-cell and inter-cell CLI, the adjacent UE 115-a and UE 115-b have approximately the same uplink timing. So, victim UE 115-b may use its own uplink timing for CLI measurement.

In some examples, the UE 115-a and the UE 115-b may be capable of full-duplex communications in high frequency bands (e.g., mmW frequency bands), which may increase the overall signaling capacity of the wireless communications system 200. For example, the UE 115-a and the UE 115-b may support compact antenna arrays to support full-duplex communications while reducing possible self-interference between transmission and reception. In some cases, however, application of a TA while operating in a full-duplex mode may lead to misalignment between uplink and downlink symbols at the UE, such that the uplink symbol occurs earlier than downlink symbol with the timing difference 205 equal to the applied TA. In cases where the TA is greater than the cyclic prefix (CP) of the uplink or downlink symbols, the UE 115-a and UE 115-b may experience increased inter-symbol-interference due to a loss of orthogonality between the uplink and downlink symbols.

To mitigate the effects of such misalignment in full-duplex, in some cases, the UE 115-a, the UE 115-b, or both, may apply a partial TA value (e.g., αTA 210) which may allow the UEs to compensate for a portion of the TA values indicated by the network. For example, the network may indicate that the UE to compensate for portion of the TA (e.g., α portion of TA), where α is a number between 0 and 1 (e.g., {0, 0.25,0.5,0.75,1}). In such cases, an α value of one (e.g., α=1) is associated with full TA compensation, while an α value of zero (e.g., α=0) is associated with no TA compensation, while fractional α values are associated with fractional or partial TA compensation.

In some cases, the UE 115-a and UE 115-b may experience increased CLI in full duplex when the UEs apply TA based on misalignments between the uplink and downlink symbols. In addition, the application of partial TA (by the UE 115-a, the UE 115-b, or both) for uplink and downlink in a full duplex setting may cause further misalignments in timing for receiving data and for performing CLI measurements, which may reduce CLI measurement accuracy and reduce overall signaling performance. Thus, to reduce the effects of timing misalignments for performing CLI measurements in cases where partial TA is applied in full-duplex scenarios, the UE 115-a and UE 115-b may support various CLI timing rules.

In a first example, a UE may be capable of maintaining two separate TAS, and may switch between TAs for different settings. For example, the UE 115-a or the UE 115-b may apply a first TA for receiving downlink data during a downlink reception occasion, and may apply a second TA for receiving reference signaling for performing CLI measurements during a CLI measurement occasion. The UEs may receive control signaling (e.g., DCI) that may indicate the different TA values or whether the UEs are capable of switching between two TA values. In some other examples, a UEs may be capable of maintaining a single TA value that may support accurate downlink reception and CLI measurement. The UE 115-a, the UE 115-b, or both, may determine various coefficients to apply to an existing TA value to support more effective alignment, or the UEs may receive control signaling to determine various TA values to apply.

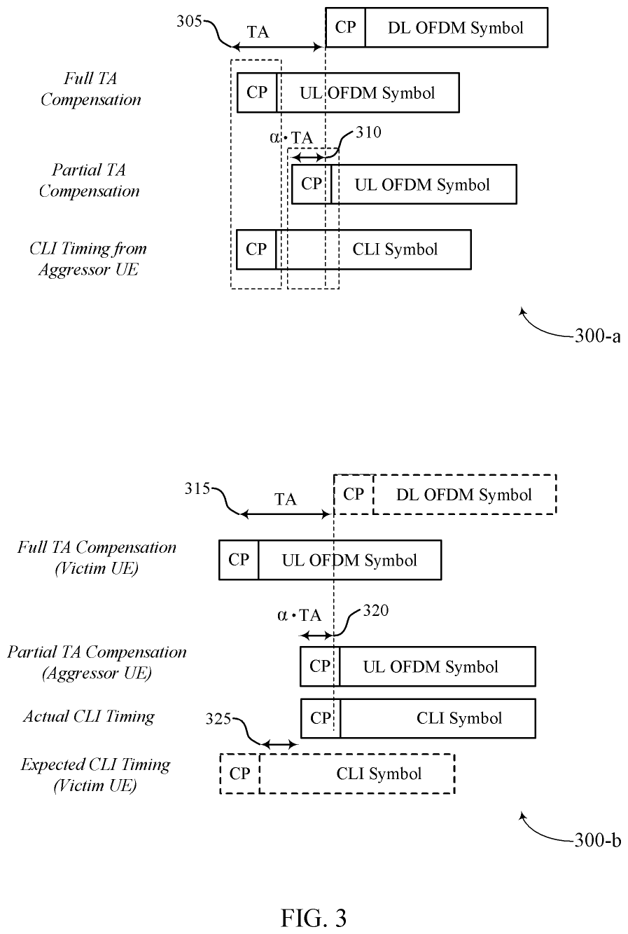

FIG. 3 illustrates example TA signaling alignment configurations 300-a and 300-b that support CLI timing alignment for partial TA in accordance with one or more aspects of the present disclosure. For example, the TA signaling alignment configurations 300-a and 300-b may illustrate possible uplink and downlink configurations between an aggressor UE and a victim UE communicating within a wireless communications system, such as wireless communications system 100 or 200 as described herein.

In some wireless communications systems, for example, in some wireless communications systems supporting TDD, the timing for a CLI symbol for performing CLI measurements (e.g., a CLI measurement occasion or a CLI timing) may be approximately equal to the OFDM uplink symbol timing for both of intra-cell and inter-cell deployments. In such cases, the CLI occurs among adjacent UEs within a cell or across adjacent cells. In some other cases, however, UEs may support partial TA procedures along with full-duplexing capabilities, and the timing for the CLI symbol for performing CLI measurements may be different from the OFDM uplink symbol timing. In such cases, (e.g., when partial TA is enabled), the aggressor uplink timing may be misaligned with the victim UE uplink timing, even in cases where the two adjacent cells are the same size, thus affecting the CLI timing and degrading CLI measurement performance.

For example, in TA signaling alignment configuration 300-a, in the victim UE, when the full TA is greater than the cyclic prefix (CP) for a, the inter-symbol interference may increase for the downlink reception, and the victim UE may adjust the full TA 305 by applying the partial TA 310, such that the applied TA is less than the CP.

In implementations where the cells for victim and aggressor UE are with the same cell size and aggressor UE is without the partial TA setting, the aggressor UE may implement a full TA 305 for its uplink transmission, and the CLI timing may be approximately equal to the full uplink TA timing. Then, the partial TA 310 (e.g., αTA) applied by the victim UE may lead to the timing misalignment for the CLI measurement, because the CP for the uplink OFDM symbol using the partial TA compensation at the victim UE may not overlap with the CLI symbol, which may lead to relatively significant interference for the CLI measurements.

Similarly, in TA signaling alignment configurations 300-b, the partial TA 320 (e.g., αTA) may be enabled at the aggressor UE, and victim UE may implement a full TA 315 based on operating in a half-duplex setting. In cases that the cells for victim and aggressor UE have roughly equivalent same cell size, the aggressor UE applies a partial TA 320, αTA, for its uplink transmission and the CLI timing, measured in victim UE, is roughly same to αTA.

In some examples, however, the victim UE may not be aware of the applied partial TA 310 applied at the aggressor UE and may adjust its TA for CLI timing, and may apply a full TA for the CLI measurement. In such cases, the application of the partial TA may lead to the timing misalignment 325 for the CLI measurement, thus reducing CLI measurement performance.

As shown in TA signaling alignment configurations 300-a and 300-b, the uplink timing between the victim and aggressor UEs may be equivalent based on various duplexing constraints or capabilities of the UEs, which may lead to misalignments In addition, in cases where the cells are different sizes, further misalignments may occur. Thus, to reduce the effects of timing misalignments for performing CLI measurements in cases where partial TA is applied in full-duplex implementations (or a combination of full duplex and half duplex implementations), the UE may support various CLI timing rules.

For example, a UE may be capable of maintaining two separate TAs, and may switch between TAs for different settings. For example, the UE may apply a first TA for receiving downlink data during a downlink reception occasion, and may apply a second TA for receiving reference signaling for performing CLI measurements during a CLI measurement occasion. The UE may receive control signaling (e.g., DCI) that may indicate the different TA values or whether the UE is able to switch between two TA values. In some other examples, a UE may be capable of maintaining a single TA value, but this TA value may support both downlink reception and for CLI measurement.

In such cases, a UE may apply different CLI timing rules in cases where partial TA is applied at the aggressor UE and a full TA is applied at the victim UE, where a partial TA is applied by the aggressor UE and a partial TA is applied by the victim UE, where a full TA is applied by the aggressor UE and a partial TA is applied by the victim UE, and where a full TA is applied by the aggressor UE and a partial TA is applied by the victim UE.

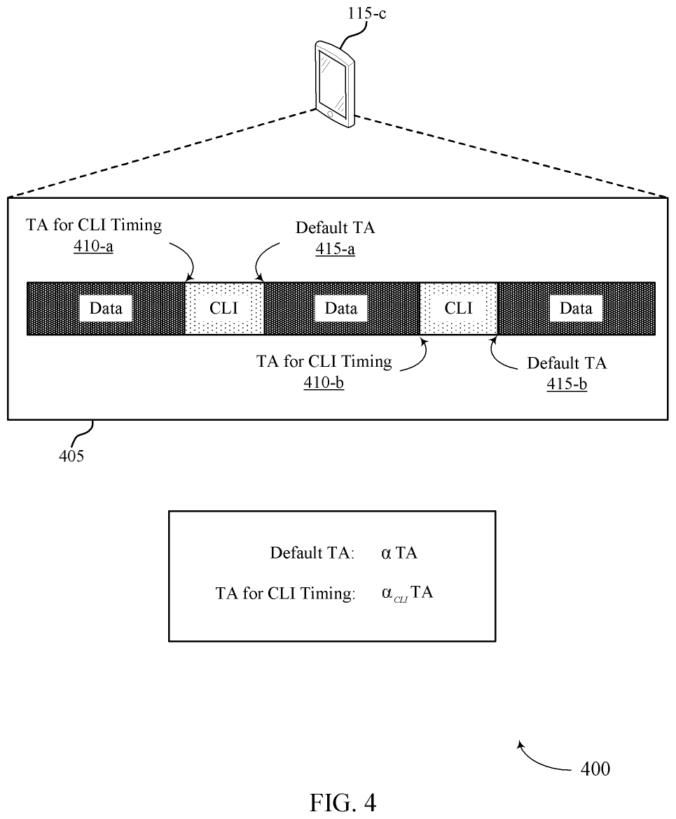

FIG. 4 illustrates an example of a TA switching configuration 400 that supports CLI timing alignment for partial TA in accordance with one or more aspects of the present disclosure. For example, TA switching configuration 400 may illustrate a signaling pattern supported by the UE 115-c, which may be an example of a UE described with reference to FIGS. 1 and 2. In some examples, the UE 115-c may be a victim UE that has a capability of maintaining a single TA or multiple TAs to apply for performing CLI measurements.

In some examples, the UE 115-c may operate in a partial TA setting, and may support a number of CLI timing operations. In such cases, the UE 115-c may apply a TA value within CLI measurement occasions. In some other examples, to mitigate misalignment between CLI timing at the UE 115-c (e.g., based on the TA applied by one or more aggressor UEs in adjacent cells), the UE 115-c may have a capability to maintain two different TAs (e.g., two different TA values), and may switch between these different TA values in different settings. For example, in switching configuration 405, the UE 115-a may switch between applying a first TA for CLI timing (e.g., α_{CLI}TA) at occasions 410-a and 410-b, and applying the second TA (e.g., αTA) for data reception occasions 415-a and 415-b. In such cases, the first TA applied for CLI may support CLI and uplink alignment for cases where the UE 115-c is operating in a full-duplex mode, and the second TA (e.g., the default TA) may be applied for downlink and uplink alignment for cases where the UE 115-c is operating in the full-duplex mode.

In switching configuration 405, the data occasions may be time intervals in which the UE 115-c receives downlink communications, transmits uplink communications, or both. In addition, the CLI measurement occasions may be corresponding time intervals which the UE 115-c transmits uplink communications, performs CLI measurement in a full-duplex mode, or both.

In some examples, within a CLI measurement occasion, the UE 115-c may apply the coefficient α_{CLI} to the TA. Then, after completion of the CLI measurement occasion, the UE 115-c switches back to applying a default coefficient value α to the TA. For example, the UE 115-c may switch between applying α_{CLI} and α depending on the timing occasion. In such examples, the default TA is applied for the data occasions for uplink data transmission with the DL data reception (e.g., αTA), and the CLI TA is applied for uplink transmission and CLI measurement occasions (e.g., α_{CLI}TA).

In some other examples, the UE 115-c may support a single TA for the CLI measurement and may apply the single TA for both data occasions and CLI measurement occasions. In such cases, the single TA may be implemented such that the single TA supports timing alignment for both the downlink and uplink data occasions and the CLI measurement occasions. In some examples, the single TA may be determined or otherwise configured by the network, and the network may transmit an indication of the single TA to the UE 115-c. In such examples, the network may configure the TA such that it may support timing alignment between data and CLI symbols. In some other examples, the UE 115-c may determine or otherwise configure the single TA (e.g. UE-self implementation) such that the TA supports alignment between the data and CLI symbols.

To further support implementations of a single TA, the network may configure CLI resources (e.g., reference signal receive power (RSRP) or received signal strength indicator (RSSI)) for the UE 115-c to use for the CLI measurement. In such cases, one CLI resource may be associated with one (or multiple) potential aggressor UEs. In some other examples, the network may transmit a CLI measurement configuration to the UE 115-c which indicates whether the CLI resource is applied with the partial TA from aggressor UE. Based on this indication of partial TA application by the aggressor UE, the UE 115-c may categorize the CLI resource as a CLI resource associated with an aggressor UE with partial TA, or a CLI resource associated with an aggressor UE without the partial TA. Additionally or alternatively, various potential aggressor UEs with similar TAs may be configured by the network to be associated with a single CLI resource. For example, each CLI resource may be associated with one or more potential aggressor UE, and each potential aggressor UE may be associated with one TA such that the UE 115-c uses the one TA for the CLI measurement. In such cases, adjacent potential aggressor UEs may be grouped and associated with one CLI resource, for example, potential aggressor UEs with similar TAs (or similar distances to a serving cell) may be associated with one CLI resource.

In some other examples, the network may include a coefficient α_{A} in the configured CLI resource configuration sent to the UE 115-c. The coefficient α_{A} may indicate the coefficient for the partial TA, and the UE 115-c may apply the coefficient to the TA in order to determine an adjusted TA to apply for the data occasions and CLI measurement occasions.

In some other examples, The UE 115-c may receive signaling from the network which indicates the TA coefficient configuration (e.g., α configuration), which may indicate that the UE should apply the coefficient α to the TA value so that the correct or real TA value is equal to αTA. In some cases, the coefficient α may be configured for various different values, and may be included in the CLI resource configuration. In such examples, a default value for the coefficient α may be one (e.g., α=1), which may indicate a full TA compensation. Additionally or alternatively, the network may define and transmit a separate message for the coefficient α, where this separate message is associated with one or more CLI resources, and where the coefficient α may be associated with multiple CLI resources.

In some other examples, the UE 115-c may receive different downlink signaling (e.g., dynamic signaling) such as DCI to indicate the coefficient for an upcoming CLI measurement. For example, UE 115-c may implement the default TA αTA, during the first data occasion, and may receive a DCI sometime before the adjacent CLI measurement occasion. The received DCI may dynamically indicate the TA variation, and that the UE 115-c is to switch from the default TA to the TA for CLI timing α_{CLI}TA at occasions 410-a. In such examples, the DCI may indicate the TA coefficient switching in cases that the coefficient set (e.g., α_{CLI}TA and αTA) is pre-defined. In some other examples, the DCI may directly indicate the different coefficient values.

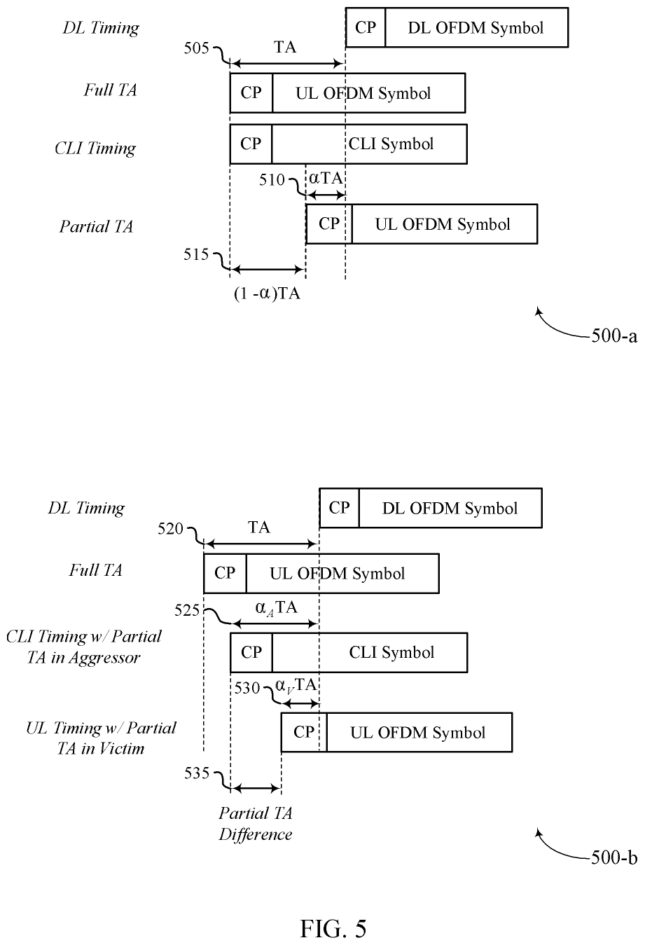

FIG. 5 illustrates example TA signaling alignment configurations 500-a and 500-b that support CLI timing alignment for partial TA in accordance with one or more aspects of the present disclosure. For example, the TA signaling alignment configurations 500-a and 500-b may illustrate possible uplink and downlink configurations between an aggressor UE and a victim UE communicating within a wireless communications system.

TA signaling alignment configuration 500-a may illustrate an implementation in which an aggressor UE is configured to apply a full TA 505, and a victim UE is configured to apply a partial TA 510 (e.g., the aggressor UE does not support a partial TA setting in this case). In such cases, TA variation between the full TA 505 and the partial TA 510 in the aggressor and victim UEs may lead to the CLI timing misalignment between the uplink OFDM symbol and the CLI symbol In such implementations, the victim UE may adjust the TA used for uplink transmission (e.g., the real-used TA).

For example, in cases that that the CLI timing is equal to the uplink timing in the aggressor UE, and the victim UE still uses its uplink timing for the CLI measurement, application of the partial TA may lead to the timing difference is (1−α)TA between the real-used TA (e.g., expected CLI timing) and actual CLI timing in the victim UE.

To support accurate timing alignment, the victim UE may apply either a single TA or multiple TAs to mitigate timing misalignment based on full and partial TA differences. For example, if using a single TA, the victim UE may set the partial TA αTA, which adjusts the timing difference 515 between CLI and uplink transmission (e.g., (1−α)TA) to be less than the CP length. If using multiple (e.g., two) TAs, the victim UE may use the full TA within the CLI measurement occasions, and may use αTA for downlink reception occasions.

TA signaling alignment configuration 500-b may illustrate an implementation in which an aggressor UE is configured to apply a partial TA 525 (e.g., α_{A}) and a victim UE is configured to apply a partial TA 530 (e.g., α_{V}), such that both the aggressor UE and the victim UE support a partial TA setting. The partial TA may be adjusted from the full TA 520 using coefficients α_{A} and α_{V}.

Based on the partial TA α_{A} applied by the aggressor UE, the victim UE may determine the coefficient α_{V} for the partial TA. For example, the victim UE may not directly estimate the aggressor UE TA, but instead may constrain the difference between α_{A} and α_{V} such that the CLI timing is aligned with the uplink timing at 535. In cases where the victim UE supports a single TA, the victim UE may reuse the α_{A} as its own coefficient for partial TA (e.g., α_{A}=α_{V}). In some other examples where the victim UE supports a single TA, the victim UE may determine a constant bound β, and may determine α_{V} based on |α_{A}−α_{V}|<β. In some other cases where the victim UE supports multiple (e.g., two) TAs, the victim UE may apply α_{A} for the CLI measurement occasions, and may apply α_{V} for the data reception measurement occasions.

In TA signaling alignment configuration 500-b, the aggressor UE may apply a partial TA for its uplink transmission, α_{A}TA, and the victim UE may apply the partial TA, α_{V}TA. The victim UE may then receive an indication of the α_{A} at the aggressor UE and may determine α_{V} based on the constraint |α_{A}−α_{V}|<β.

In some other examples, the aggressor UE may be configured to apply a partial TA and the victim UE may be configured to apply a full TA. In cases where the partial TA leads to a CLI timing misalignment, and since the CLI measurement is transparent for the aggressor UE, the victim UE switches to a half-duplex mode from a full-duplex mode. In a half-duplex mode, the victim UE uses the α_{A}TA for its CLI measurement, or may ignore the CLI measurement when performing uplink transmissions. Additionally or alternatively, the victim UE may use the full TA for the CLI measurement.

In some other examples both the aggressor UE and the victim UE may be configured to apply a full TA, and the victim UE may apply the full TA timing for CLI, or the victim UE may select or prioritize the TA used for the data reception occasions.

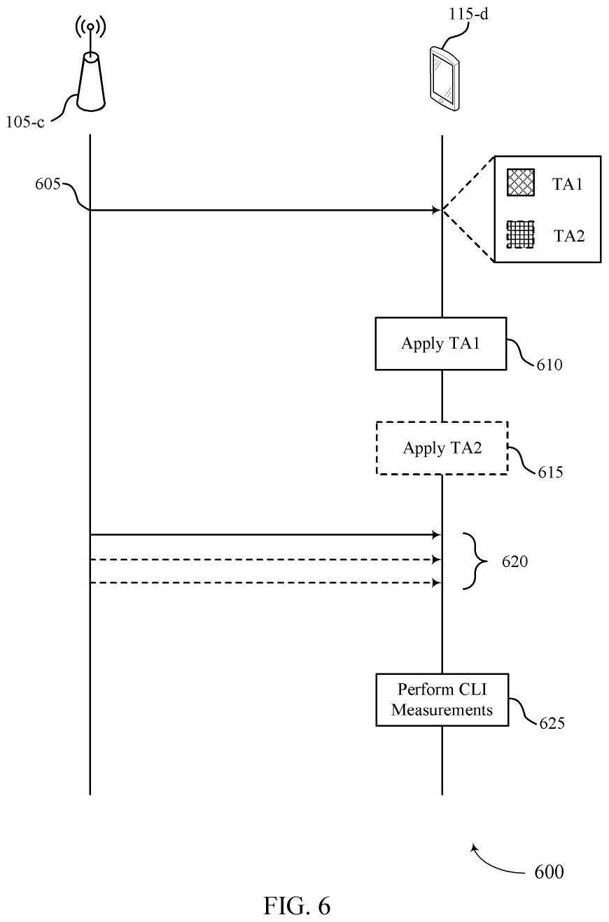

FIG. 6 illustrates an example of a process flow 600 that supports CLI timing alignment for partial TA in accordance with one or more aspects of the present disclosure. In some examples, process flow 600 may implement aspects of wireless communications system 100. The process flow 600 may include UE 115-d, which may each be an example of a UE 115 as described herein, and may be an example of a wireless device as described herein. The process flow 600 may also include a network entity 105-c, which may each be an example of a network entity as described herein. Alternative examples of the following process flow may be implemented, where some steps are performed in a different order than described or are not performed at all. In some cases, steps may include additional features not mentioned below, or further steps may be added.

At 605, the network entity 105-c may transmit, and the UE 115-d may receive, an indication of a first TA parameter (e.g., TA1) to apply for receiving one or more downlink messages and a second TA parameter (e.g., TA2) to apply for receiving one or more reference signals associated with one or more CLI measurements. In some examples, the first TA parameter is associated with a first TA coefficient and the second TA parameter is associated with the second TA coefficient, and the first TA parameter is different from the second TA parameter based on the first and second TA coefficients. In some examples, the second TA parameter is derived or otherwise based on the first TA parameter, and the different between the first TA parameter and the second TA parameter is less than a threshold timing offset (e.g., a TA offset). In some cases, the first TA parameter and the second TA parameter may be full TA parameters, partial TA parameters, or a combination thereof.

At 610, the UE 115-d may apply the first TA parameter and may receive the one or more downlink messages based at least in part on applying the first TA parameter during a first data reception occasion. In some examples, the UE 115-d may apply the first TA coefficient to the first TA parameter, and may receive the one or more downlink messages based on applying the first TA coefficient to the first TA parameter.

At 615 the UE 115-d may apply the second TA parameter to receive the one or more reference signals during a CLI measurement occasion. In some examples, the UE 115-d may apply the second TA coefficient to the second TA parameter, and may receive the one or more reference signals based on applying the second TA coefficient to the second TA parameter. In some examples, the UE 115-d may receive a CLI measurement configuration that indicates one or more CLI measurement resources to use to perform CLI measurements during the CLI measurement occasions. For example, the CLI measurement configuration may indicate whether a TA parameter is applied to the one or more CLI measurement resources. In some cases, the UE 115-d may receive a downlink message that is separate from the CLI measurement configuration that indicates a TA coefficient that is associated with the one or more CLI measurement resources for performing the one or more CLI measurements.

At 620, the UE 115-d may receive one or more reference signals during a CLI measurement occasion. In some examples, the UE 115-d may switch between applying the first TA coefficient to the first TA parameter during the first data reception occasion and the second TA coefficient to the second TA parameter during the CLI measurement occasion.

At 625, the UE 115-d may perform one or more CLI measurements based on applying the second TA parameter to receive the one or more reference signals. In some examples, the UE 115-d may receive a downlink control message (e.g., a DCI) that includes an indication of the second TA parameter, and the UE 115-d may perform one or more CLI measurements based on the received indication of the second TA parameter. In some cases, the indication of the second TA parameter instructs the UE 115-d to switch between applying the first TA parameter during the first data reception and applying the second TA parameter during the CLI measurement occasion. In some examples, the indication of the second TA parameter indicates a value of the first TA parameter, the second TA parameter, or both.

In some cases, the wireless device is a first wireless device and a misalignment may occur between an uplink transmission of a second wireless device and the CLI measurement occasion, the data reception occasion, or both. In such cases, the UE 115-d may apply the first TA parameter and the second TA parameter based on prioritizing reception of the one or more downlink messages over performing the one or more CLI measurements. In some examples, the value of a TA parameter is associated with a timing different between the CLI measurement occasion and an uplink transmission of a second wireless device, and the UE 115-d may apply the value of the TA parameter such that the timing different between the CLI measurement occasion and the uplink transmission is less than a threshold timing difference. In some other cases, the UE 115-d may switch from a full-duplex mode to a half-duplex mode based on the misalignment between the CLI measurement occasion and the uplink transmission of the second wireless device. The UE 115-d may then perform CLI measurements based on applying the TA parameter and switching duplexing modes.

In some examples, the first TA parameter includes a full TA value and the second TA parameter includes a partial TA value. The UE 115-d may receive the one or more downlink messages based on applying the full TA value, and may perform the one or more CLI measurements based on applying the partial TA value.

In some examples, the UE 115-d may receive only a single TA parameter (e.g., an indication of a single TA parameter via a downlink control message) to apply for receiving one or more downlink messages and to apply for receiving one or more reference signals associated with one or more CLI measurements.

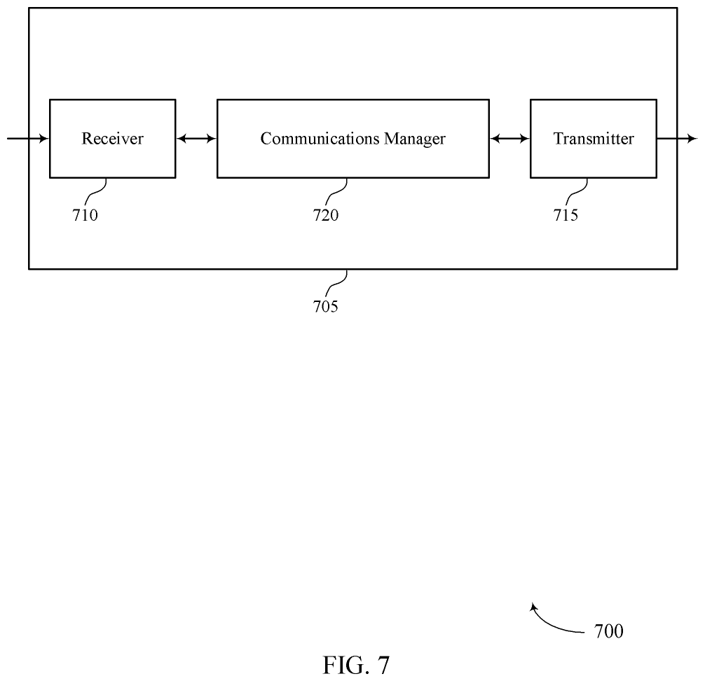

FIG. 7 shows a block diagram 700 of a device 705 that supports CLI timing alignment for partial TA in accordance with one or more aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to CLI timing alignment for partial TA). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to CLI timing alignment for partial TA). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of CLI timing alignment for partial TA as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a wireless device in accordance with examples as disclosed herein. For example, the communications manager 720 may be configured as or otherwise support a means for receiving an indication of a first TA parameter to apply for receiving one or more downlink messages and a second TA parameter to apply for receiving one or more reference signals associated with one or more CLI measurements. The communications manager 720 may be configured as or otherwise support a means for receiving the one or more downlink messages based on applying the first TA parameter during a first data reception occasion. The communications manager 720 may be configured as or otherwise support a means for performing the one or more CLI measurements based on applying the second TA parameter to receive the one or more reference signals during a CLI measurement occasion.

Additionally, or alternatively, the communications manager 720 may support wireless communication at a wireless device in accordance with examples as disclosed herein. For example, the communications manager 720 may be configured as or otherwise support a means for receiving an indication of a TA parameter to apply for receiving one or more downlink messages and to apply for receiving one or more reference signals associated with one or more CLI measurements. The communications manager 720 may be configured as or otherwise support a means for receiving the one or more downlink messages based on applying the TA parameter during a data reception occasion. The communications manager 720 may be configured as or otherwise support a means for performing the one or more CLI measurements based on applying the TA parameter to receive the one or more reference signals during a CLI measurement occasion.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for more efficient utilization of communication resources, more efficient interference mitigation, and increased CLI timing measurement accuracy.

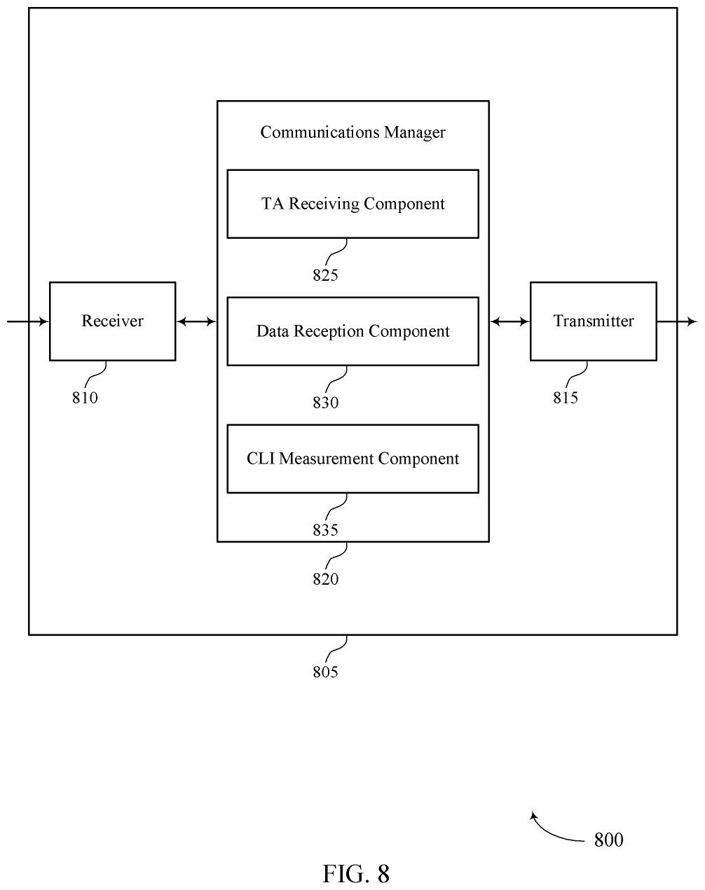

FIG. 8 shows a block diagram 800 of a device 805 that supports CLI timing alignment for partial TA in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to CLI timing alignment for partial TA). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to CLI timing alignment for partial TA). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of CLI timing alignment for partial TA as described herein. For example, the communications manager 820 may include a TA receiving component 825, a data reception component 830, a CLI measurement component 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a wireless device in accordance with examples as disclosed herein. The TA receiving component 825 may be configured as or otherwise support a means for receiving an indication of a first TA parameter to apply for receiving one or more downlink messages and a second TA parameter to apply for receiving one or more reference signals associated with one or more CLI measurements. The data reception component 830 may be configured as or otherwise support a means for receiving the one or more downlink messages based on applying the first TA parameter during a first data reception occasion. The CLI measurement component 835 may be configured as or otherwise support a means for performing the one or more CLI measurements based on applying the second TA parameter to receive the one or more reference signals during a CLI measurement occasion.

Additionally, or alternatively, the communications manager 820 may support wireless communication at a wireless device in accordance with examples as disclosed herein. The TA receiving component 825 may be configured as or otherwise support a means for receiving an indication of a TA parameter to apply for receiving one or more downlink messages and to apply for receiving one or more reference signals associated with one or more CLI measurements. The data reception component 830 may be configured as or otherwise support a means for receiving the one or more downlink messages based on applying the TA parameter during a data reception occasion. The CLI measurement component 835 may be configured as or otherwise support a means for performing the one or more CLI measurements based on applying the TA parameter to receive the one or more reference signals during a CLI measurement occasion.

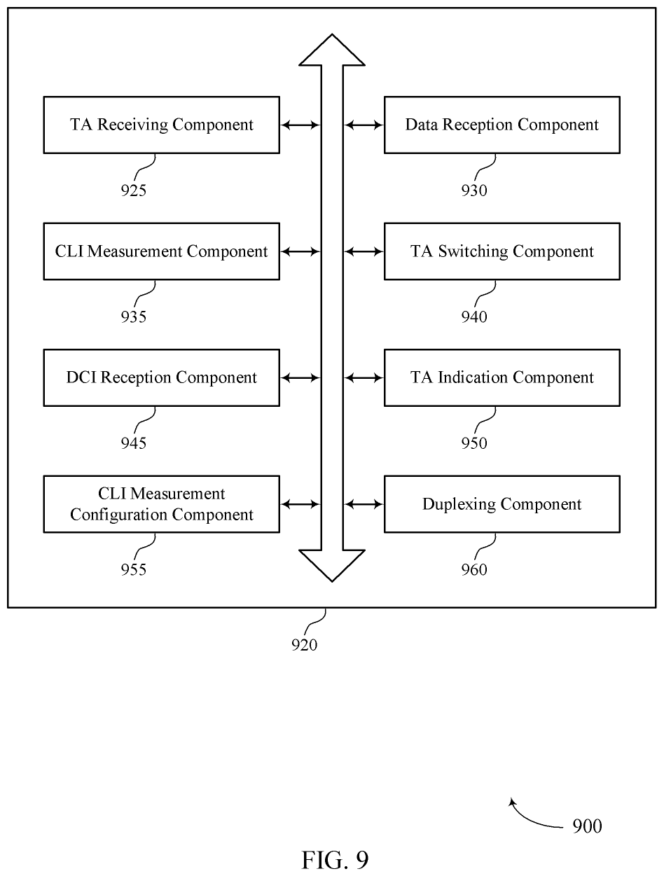

FIG. 9 shows a block diagram 900 of a communications manager 920 that supports CLI timing alignment for partial TA in accordance with one or more aspects of the present disclosure. The communications manager 920 may be an example of aspects of a communications manager 720, a communications manager 820, or both, as described herein. The communications manager 920, or various components thereof, may be an example of means for performing various aspects of CLI timing alignment for partial TA as described herein. For example, the communications manager 920 may include a TA receiving component 925, a data reception component 930, a CLI measurement component 935, a TA switching component 940, a DCI reception component 945, a TA indication component 950, a CLI measurement configuration component 955, a duplexing component 960, or any combination thereof. Each of these components may communicate, directly or indirectly, with one another (e.g., via one or more buses).

The communications manager 920 may support wireless communication at a wireless device in accordance with examples as disclosed herein. The TA receiving component 925 may be configured as or otherwise support a means for receiving an indication of a first TA parameter to apply for receiving one or more downlink messages and a second TA parameter to apply for receiving one or more reference signals associated with one or more CLI measurements. The data reception component 930 may be configured as or otherwise support a means for receiving the one or more downlink messages based on applying the first TA parameter during a first data reception occasion. The CLI measurement component 935 may be configured as or otherwise support a means for performing the one or more CLI measurements based on applying the second TA parameter to receive the one or more reference signals during a CLI measurement occasion.

In some examples, the first TA parameter is associated with a first TA coefficient and the second TA parameter is associated with a second TA coefficient, and the TA switching component 940 may be configured as or otherwise support a means for switching between applying the first TA coefficient to the first TA parameter during the first data reception occasion and the second TA coefficient to the second TA parameter during the CLI measurement occasion.

In some examples, the data reception component 930 may be configured as or otherwise support a means for receiving the one or more downlink messages based on applying the first TA coefficient. In some examples, the CLI measurement component 935 may be configured as or otherwise support a means for performing the one or more CLI measurements based on applying the second TA coefficient, where the first TA parameter is different from the second TA parameter based on the first TA coefficient, the second TA coefficient, or both.

In some examples, the DCI reception component 945 may be configured as or otherwise support a means for receiving, prior to the CLI measurement occasion, a downlink control message including an indication of the second TA parameter. In some examples, the CLI measurement component 935 may be configured as or otherwise support a means for performing the one or more CLI measurements based on the indication of the second TA parameter.

In some examples, the indication of the second TA parameter instructs the wireless device to switch between applying the first TA parameter during the first data reception occasion and applying the second TA parameter during the CLI measurement occasion.

In some examples, the indication of the second TA parameter indicates a value of the first TA parameter, the second TA parameter, or both.

In some examples, the first TA parameter includes a full TA value and the second TA parameter includes a partial TA value, and the data reception component 930 may be configured as or otherwise support a means for receiving the one or more downlink messages based on applying the full TA value. In some examples, the first TA parameter includes a full TA value and the second TA parameter includes a partial TA value, and the CLI measurement component 935 may be configured as or otherwise support a means for performing the one or more CLI measurements based on applying the partial TA value.

In some examples, the second TA parameter is based on the first TA parameter. In some examples, a difference between the first TA parameter and the second TA parameter is less than a threshold timing offset.

In some examples, the wireless device is a first wireless device, and a misalignment occurs between an uplink transmission of a second wireless device and the CLI measurement occasion, and the TA switching component 940 may be configured as or otherwise support a means for applying the first TA parameter and the second TA parameter based on prioritizing reception of the one or more downlink messages over performing the one or more CLI measurements.

In some examples, the first TA parameter and the second TA parameter include full TA parameters, partial TA parameters, or a combination thereof.

Additionally, or alternatively, the communications manager 920 may support wireless communication at a wireless device in accordance with examples as disclosed herein. In some examples, the TA receiving component 925 may be configured as or otherwise support a means for receiving an indication of a TA parameter to apply for receiving one or more downlink messages and to apply for receiving one or more reference signals associated with one or more CLI measurements. In some examples, the data reception component 930 may be configured as or otherwise support a means for receiving the one or more downlink messages based on applying the TA parameter during a data reception occasion. In some examples, the CLI measurement component 935 may be configured as or otherwise support a means for performing the one or more CLI measurements based on applying the TA parameter to receive the one or more reference signals during a CLI measurement occasion.

In some examples, the DCI reception component 945 may be configured as or otherwise support a means for receiving the indication of the TA parameter as a downlink control message, the downlink control message indicating a value of the TA parameter.

In some examples, the TA indication component 950 may be configured as or otherwise support a means for receiving the indication of the TA parameter, where a value of the TA parameter is determined based on the indication of the TA parameter.

In some examples, the CLI measurement configuration component 955 may be configured as or otherwise support a means for receiving a CLI measurement configuration that indicates one or more CLI measurement resources to use for performing the one or more CLI measurements, where the CLI measurement configuration further indicates whether the TA parameter is applied to the one or more CLI measurement resources.

In some examples, the TA parameter is associated with a partial TA value or a full TA value.

In some examples, the CLI measurement configuration component 955 may be configured as or otherwise support a means for receiving a CLI measurement configuration that indicates a partial TA value. In some examples, the TA switching component 940 may be configured as or otherwise support a means for applying the TA parameter during the data reception occasion, the CLI measurement occasion, or both, based on the partial TA value.

In some examples, the CLI measurement configuration component 955 may be configured as or otherwise support a means for receiving a CLI measurement configuration that includes a TA coefficient, where the TA coefficient is associated with one or more CLI measurement resources for performing the one or more CLI measurements.

In some examples, the CLI measurement component 935 may be configured as or otherwise support a means for receiving, in a downlink message separate from a CLI measurement configuration, a TA coefficient that is associated with one or more CLI measurement resources for performing the one or more CLI measurements.

In some examples, the wireless device is a first wireless device, and a value of the TA parameter is associated with a timing difference between the CLI measurement occasion and an uplink transmission of a second wireless device, and the TA switching component 940 may be configured as or otherwise support a means for applying the value of the TA parameter such that the timing difference between the CLI measurement occasion and the uplink transmission is less than a threshold time difference.

In some examples, the wireless device is a first wireless device, and the TA receiving component 925 may be configured as or otherwise support a means for receiving an indication of a partial TA coefficient applied by a second wireless device, where a value of the TA parameter is based on application of the partial TA coefficient to the TA parameter.

In some examples, the wireless device is a first wireless device, and the TA parameter is based on a second TA parameter associated with a second wireless device. In some examples, a difference between the TA parameter and the second TA parameter is less than a threshold timing offset.

In some examples, the duplexing component 960 may be configured as or otherwise support a means for switching from a full-duplex mode to a half-duplex mode based on a determined misalignment between the CLI measurement occasion and a corresponding uplink transmission of a second wireless device. In some examples, the CLI measurement component 935 may be configured as or otherwise support a means for performing the one or more CLI measurements based on applying the TA parameter and switching from the full-duplex mode to the half-duplex mode.

In some examples, the wireless device is a first wireless device, and a misalignment occurs between an uplink transmission of a second wireless device and the CLI measurement occasion, and the TA switching component 940 may be configured as or otherwise support a means for applying the TA parameter based on prioritizing reception of the one or more downlink messages over performing the one or more CLI measurements.

In some examples, the TA parameter includes a full TA parameter or a partial TA parameters.

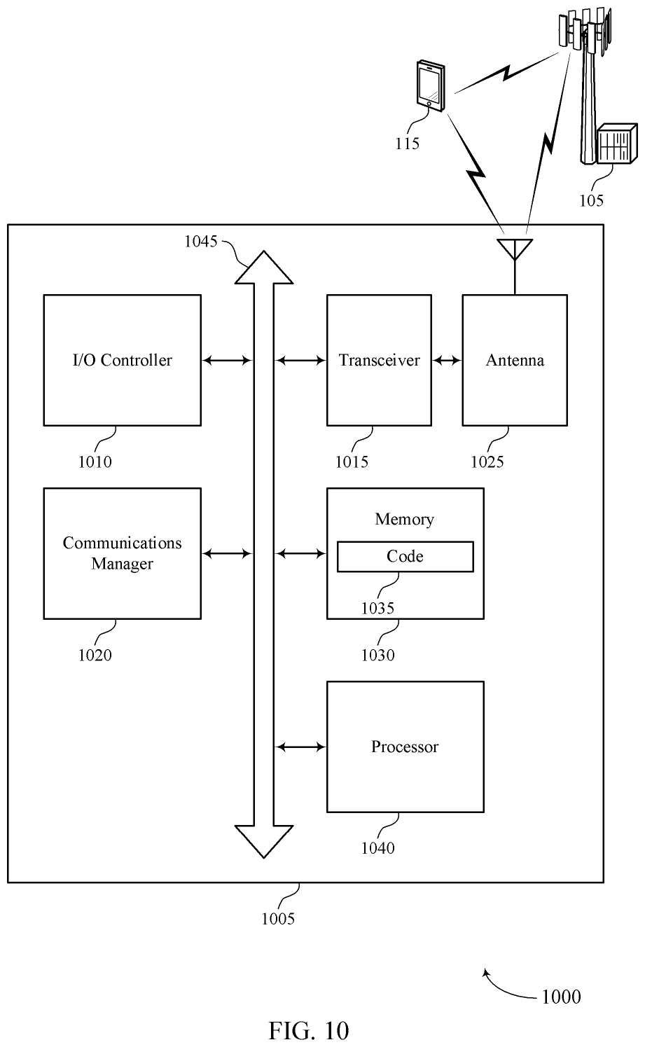

FIG. 10 shows a diagram of a system 1000 including a device 1005 that supports CLI timing alignment for partial TA in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting CLI timing alignment for partial TA). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communication at a wireless device in accordance with examples as disclosed herein. For example, the communications manager 1020 may be configured as or otherwise support a means for receiving an indication of a first TA parameter to apply for receiving one or more downlink messages and a second TA parameter to apply for receiving one or more reference signals associated with one or more CLI measurements. The communications manager 1020 may be configured as or otherwise support a means for receiving the one or more downlink messages based on applying the first TA parameter during a first data reception occasion. The communications manager 1020 may be configured as or otherwise support a means for performing the one or more CLI measurements based on applying the second TA parameter to receive the one or more reference signals during a CLI measurement occasion.

Additionally, or alternatively, the communications manager 1020 may support wireless communication at a wireless device in accordance with examples as disclosed herein. For example, the communications manager 1020 may be configured as or otherwise support a means for receiving an indication of a TA parameter to apply for receiving one or more downlink messages and to apply for receiving one or more reference signals associated with one or more CLI measurements. The communications manager 1020 may be configured as or otherwise support a means for receiving the one or more downlink messages based on applying the TA parameter during a data reception occasion. The communications manager 1020 may be configured as or otherwise support a means for performing the one or more CLI measurements based on applying the TA parameter to receive the one or more reference signals during a CLI measurement occasion.

By including or configuring the communications manager 1020 in accordance with examples as described herein, the device 1005 may support techniques for improved communication reliability, more efficient utilization of communication resources, improved coordination and timing alignment between devices, more efficient utilization of communication resources, more efficient interference mitigation, and increased CLI timing measurement accuracy.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of CLI timing alignment for partial TA as described herein, or the processor 1040 and the memory 1030 may be otherwise configured to perform or support such operations.

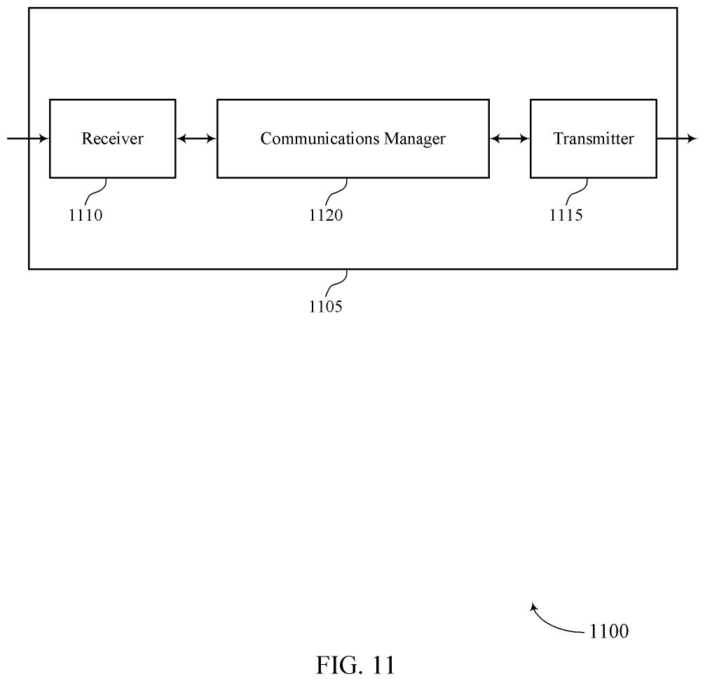

FIG. 11 shows a block diagram 1100 of a device 1105 that supports CLI timing alignment for partial TA in accordance with one or more aspects of the present disclosure. The device 1105 may be an example of aspects of a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of CLI timing alignment for partial TA as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network entity in accordance with examples as disclosed herein. For example, the communications manager 1120 may be configured as or otherwise support a means for transmitting an indication of a first TA parameter associated with one or more downlink messages and a second TA parameter associated with one or more reference signals corresponding to one or more CLI measurements. The communications manager 1120 may be configured as or otherwise support a means for transmitting the one or more downlink messages during a first data reception occasion. The communications manager 1120 may be configured as or otherwise support a means for transmitting the one or more reference signals during a CLI measurement occasion. The communications manager 1120 may be configured as or otherwise support a means for receiving the one or more CLI measurements based on the first TA parameter and the second TA parameter.

Additionally, or alternatively, the communications manager 1120 may support wireless communication at a network entity in accordance with examples as disclosed herein. For example, the communications manager 1120 may be configured as or otherwise support a means for transmitting an indication of a TA parameter associated with one or more downlink messages and associated with one or more reference signals corresponding to one or more CLI measurements. The communications manager 1120 may be configured as or otherwise support a means for transmitting the one or more downlink messages during a data reception occasion. The communications manager 1120 may be configured as or otherwise support a means for transmitting the one or more reference signals during a CLI measurement occasion. The communications manager 1120 may be configured as or otherwise support a means for receiving the one or more CLI measurements based on the TA parameter.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for more efficient utilization of communication resources, more efficient interference mitigation, and increased CLI timing measurement accuracy

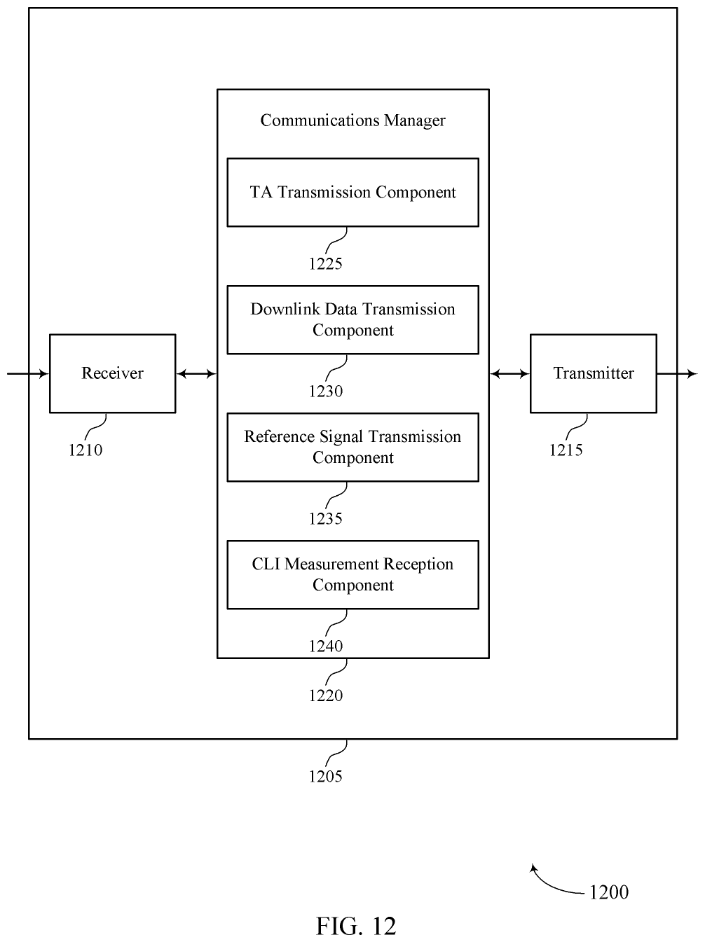

FIG. 12 shows a block diagram 1200 of a device 1205 that supports CLI timing alignment for partial TA in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of CLI timing alignment for partial TA as described herein. For example, the communications manager 1220 may include a TA transmission component 1225, a downlink data transmission component 1230, a reference signal transmission component 1235, a CLI measurement reception component 1240, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication at a network entity in accordance with examples as disclosed herein. The TA transmission component 1225 may be configured as or otherwise support a means for transmitting an indication of a first TA parameter associated with one or more downlink messages and a second TA parameter associated with one or more reference signals corresponding to one or more CLI measurements. The downlink data transmission component 1230 may be configured as or otherwise support a means for transmitting the one or more downlink messages during a first data reception occasion. The reference signal transmission component 1235 may be configured as or otherwise support a means for transmitting the one or more reference signals during a CLI measurement occasion. The CLI measurement reception component 1240 may be configured as or otherwise support a means for receiving the one or more CLI measurements based on the first TA parameter and the second TA parameter.

Additionally, or alternatively, the communications manager 1220 may support wireless communication at a network entity in accordance with examples as disclosed herein. The TA transmission component 1225 may be configured as or otherwise support a means for transmitting an indication of a TA parameter associated with one or more downlink messages and associated with one or more reference signals corresponding to one or more CLI measurements. The downlink data transmission component 1230 may be configured as or otherwise support a means for transmitting the one or more downlink messages during a data reception occasion. The reference signal transmission component 1235 may be configured as or otherwise support a means for transmitting the one or more reference signals during a CLI measurement occasion. The CLI measurement reception component 1240 may be configured as or otherwise support a means for receiving the one or more CLI measurements based on the TA parameter.

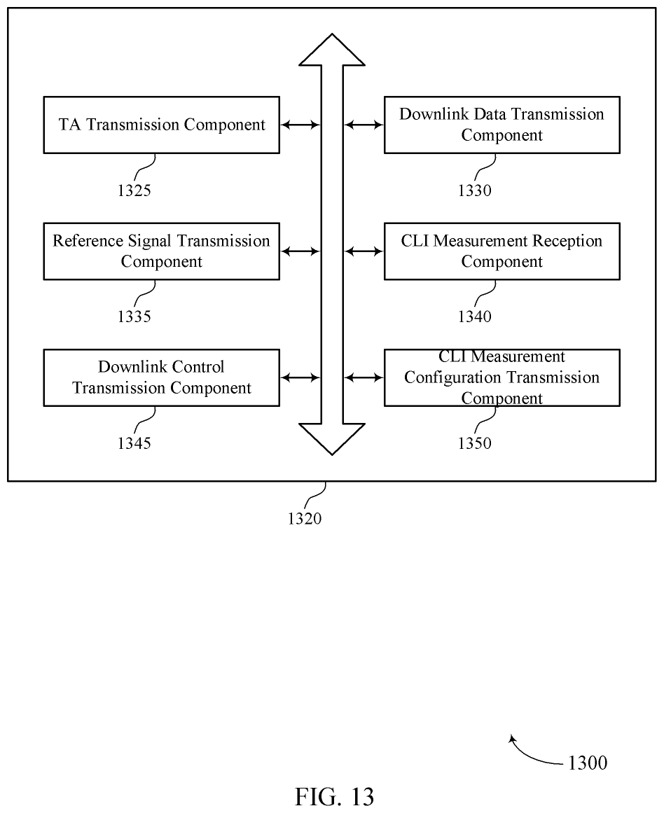

FIG. 13 shows a block diagram 1300 of a communications manager 1320 that supports CLI timing alignment for partial TA in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of CLI timing alignment for partial TA as described herein. For example, the communications manager 1320 may include a TA transmission component 1325, a downlink data transmission component 1330, a reference signal transmission component 1335, a CLI measurement reception component 1340, a downlink control transmission component 1345, a CLI measurement configuration transmission component 1350, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communication at a network entity in accordance with examples as disclosed herein. The TA transmission component 1325 may be configured as or otherwise support a means for transmitting an indication of a first TA parameter associated with one or more downlink messages and a second TA parameter associated with one or more reference signals corresponding to one or more CLI measurements. The downlink data transmission component 1330 may be configured as or otherwise support a means for transmitting the one or more downlink messages during a first data reception occasion. The reference signal transmission component 1335 may be configured as or otherwise support a means for transmitting the one or more reference signals during a CLI measurement occasion. The CLI measurement reception component 1340 may be configured as or otherwise support a means for receiving the one or more CLI measurements based on the first TA parameter and the second TA parameter.

In some examples, the downlink control transmission component 1345 may be configured as or otherwise support a means for transmitting, prior to the CLI measurement occasion, a downlink control message including an indication of the second TA parameter. In some examples, the CLI measurement reception component 1340 may be configured as or otherwise support a means for receiving the one or more CLI measurements based on the indication of the second TA parameter.

In some examples, the first TA parameter includes a full TA value and the second TA parameter includes a partial TA value, and the downlink data transmission component 1330 may be configured as or otherwise support a means for transmitting the one or more downlink messages based on the full TA value. In some examples, the first TA parameter includes a full TA value and the second TA parameter includes a partial TA value, and the CLI measurement reception component 1340 may be configured as or otherwise support a means for receiving the one or more CLI measurements based on the partial TA value.

Additionally, or alternatively, the communications manager 1320 may support wireless communication at a network entity in accordance with examples as disclosed herein. In some examples, the TA transmission component 1325 may be configured as or otherwise support a means for transmitting an indication of a TA parameter associated with one or more downlink messages and associated with one or more reference signals corresponding to one or more CLI measurements. In some examples, the downlink data transmission component 1330 may be configured as or otherwise support a means for transmitting the one or more downlink messages during a data reception occasion. In some examples, the reference signal transmission component 1335 may be configured as or otherwise support a means for transmitting the one or more reference signals during a CLI measurement occasion. In some examples, the CLI measurement reception component 1340 may be configured as or otherwise support a means for receiving the one or more CLI measurements based on the TA parameter.

In some examples, the downlink control transmission component 1345 may be configured as or otherwise support a means for transmitting a downlink control message including an indication of a value of the TA parameter.

In some examples, the CLI measurement configuration transmission component 1350 may be configured as or otherwise support a means for transmitting a CLI measurement configuration that indicates one or more CLI measurement resources corresponding to the one or more CLI measurements, where the CLI measurement configuration further indicates whether the TA parameter is applied to the one or more CLI measurement resources.

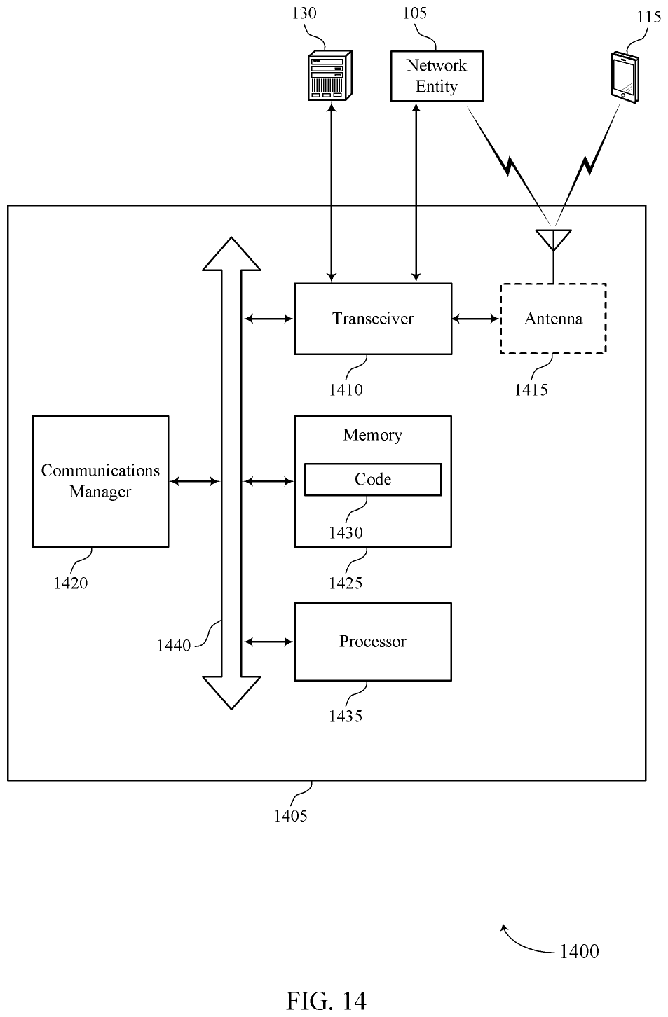

FIG. 14 shows a diagram of a system 1400 including a device 1405 that supports CLI timing alignment for partial TA in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, a memory 1425, code 1430, and a processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or memory components (for example, the processor 1435, or the memory 1425, or both), may be included in a chip or chip assembly that is installed in the device 1405. In some examples, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code 1430 including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting CLI timing alignment for partial TA). For example, the device 1405 or a component of the device 1405 may include a processor 1435 and memory 1425 coupled with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405. The processor 1435 may be any one or more suitable processors capable of executing scripts or instructions of one or more software programs stored in the device 1405 (such as within the memory 1425). In some implementations, the processor 1435 may be a component of a processing system. A processing system may generally refer to a system or series of machines or components that receives inputs and processes the inputs to produce a set of outputs (which may be passed to other systems or components of, for example, the device 1405). For example, a processing system of the device 1405 may refer to a system including the various other components or subcomponents of the device 1405, such as the processor 1435, or the transceiver 1410, or the communications manager 1420, or other components or combinations of components of the device 1405. The processing system of the device 1405 may interface with other components of the device 1405, and may process information received from other components (such as inputs or signals) or output information to other components. For example, a chip or modem of the device 1405 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1405 may transmit information output from the chip or modem. Additionally, or alternatively, in some implementations, the one or more interfaces may refer to an interface between the processing system of the chip or modem and a receiver, such that the device 1405 may obtain information or signal inputs, and the information may be passed to the processing system. A person having ordinary skill in the art will readily recognize that a first interface also may obtain information or signal inputs, and a second interface also may output information or signal outputs.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communication at a network entity in accordance with examples as disclosed herein. For example, the communications manager 1420 may be configured as or otherwise support a means for transmitting an indication of a first TA parameter associated with one or more downlink messages and a second TA parameter associated with one or more reference signals corresponding to one or more CLI measurements. The communications manager 1420 may be configured as or otherwise support a means for transmitting the one or more downlink messages during a first data reception occasion. The communications manager 1420 may be configured as or otherwise support a means for transmitting the one or more reference signals during a CLI measurement occasion. The communications manager 1420 may be configured as or otherwise support a means for receiving the one or more CLI measurements based on the first TA parameter and the second TA parameter.

Additionally, or alternatively, the communications manager 1420 may support wireless communication at a network entity in accordance with examples as disclosed herein. For example, the communications manager 1420 may be configured as or otherwise support a means for transmitting an indication of a TA parameter associated with one or more downlink messages and associated with one or more reference signals corresponding to one or more CLI measurements. The communications manager 1420 may be configured as or otherwise support a means for transmitting the one or more downlink messages during a data reception occasion. The communications manager 1420 may be configured as or otherwise support a means for transmitting the one or more reference signals during a CLI measurement occasion. The communications manager 1420 may be configured as or otherwise support a means for receiving the one or more CLI measurements based on the TA parameter.

By including or configuring the communications manager 1420 in accordance with examples as described herein, the device 1405 may support techniques for improved communication reliability, more efficient utilization of communication resources, improved coordination and timing alignment between devices, more efficient utilization of communication resources, more efficient interference mitigation, and increased CLI timing measurement accuracy.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, the processor 1435, the memory 1425, the code 1430, or any combination thereof. For example, the code 1430 may include instructions executable by the processor 1435 to cause the device 1405 to perform various aspects of CLI timing alignment for partial TA as described herein, or the processor 1435 and the memory 1425 may be otherwise configured to perform or support such operations.

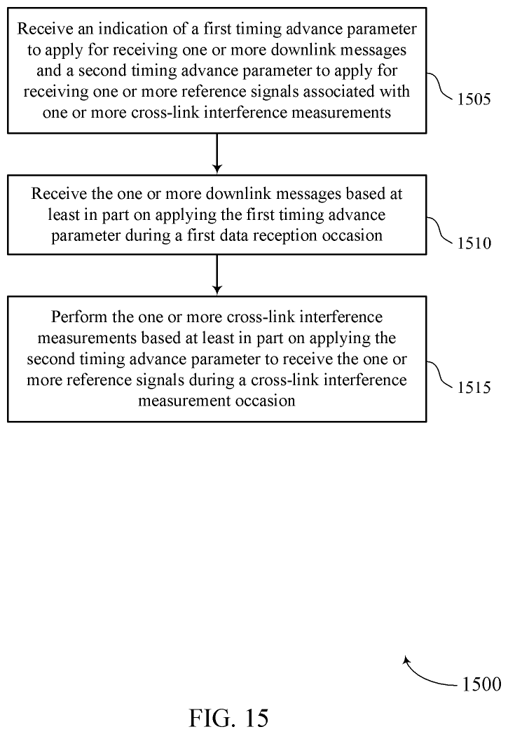

FIG. 15 shows a flowchart illustrating a method 1500 that supports CLI timing alignment for partial TA in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving an indication of a first TA parameter to apply for receiving one or more downlink messages and a second TA parameter to apply for receiving one or more reference signals associated with one or more CLI measurements. The operations of 1505 may be performed in accordance with examples as disclosed herein. In some examples, aspects of the operations of 1505 may be performed by a TA receiving component 925 as described with reference to FIG. 9.

At 1510, the method may include receiving the one or more downlink messages based on applying the first TA parameter during a first data reception occasion. The operations of 1510 may be performed in accordance with examples as disclosed herein. In some examples, aspects of the operations of 1510 may be performed by a data reception component 930 as described with reference to FIG. 9.

At 1515, the method may include performing the one or more CLI measurements based on applying the second TA parameter to receive the one or more reference signals during a CLI measurement occasion. The operations of 1515 may be performed in accordance with examples as disclosed herein. In some examples, aspects of the operations of 1515 may be performed by a CLI measurement component 935 as described with reference to FIG. 9.

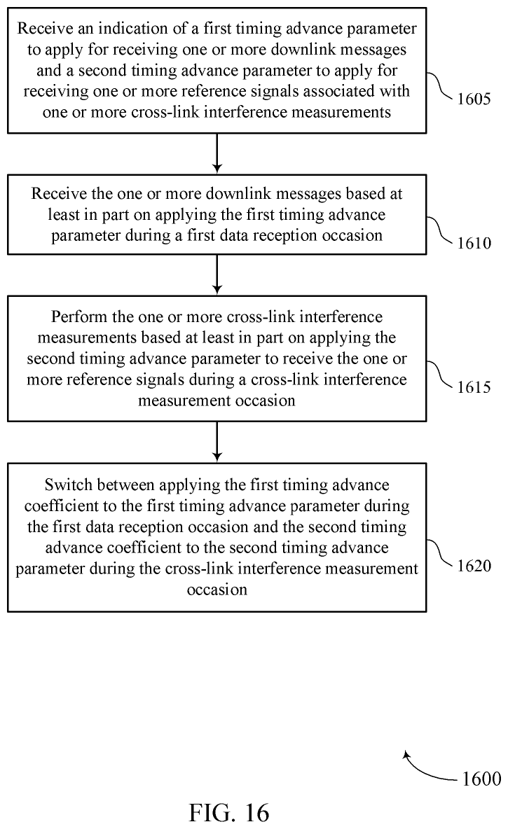

FIG. 16 shows a flowchart illustrating a method 1600 that supports CLI timing alignment for partial TA in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include receiving an indication of a first TA parameter to apply for receiving one or more downlink messages and a second TA parameter to apply for receiving one or more reference signals associated with one or more CLI measurements. The operations of 1605 may be performed in accordance with examples as disclosed herein. In some examples, aspects of the operations of 1605 may be performed by a TA receiving component 925 as described with reference to FIG. 9.

At 1610, the method may include receiving the one or more downlink messages based on applying the first TA parameter during a first data reception occasion. The operations of 1610 may be performed in accordance with examples as disclosed herein. In some examples, aspects of the operations of 1610 may be performed by a data reception component 930 as described with reference to FIG. 9.

At 1615, the method may include performing the one or more CLI measurements based on applying the second TA parameter to receive the one or more reference signals during a CLI measurement occasion. The operations of 1615 may be performed in accordance with examples as disclosed herein. In some examples, aspects of the operations of 1615 may be performed by a CLI measurement component 935 as described with reference to FIG. 9.

At 1620, the method may include switching between applying the first TA coefficient to the first TA parameter during the first data reception occasion and the second TA coefficient to the second TA parameter during the CLI measurement occasion. The operations of 1620 may be performed in accordance with examples as disclosed herein. In some examples, aspects of the operations of 1620 may be performed by a TA switching component 940 as described with reference to FIG. 9.

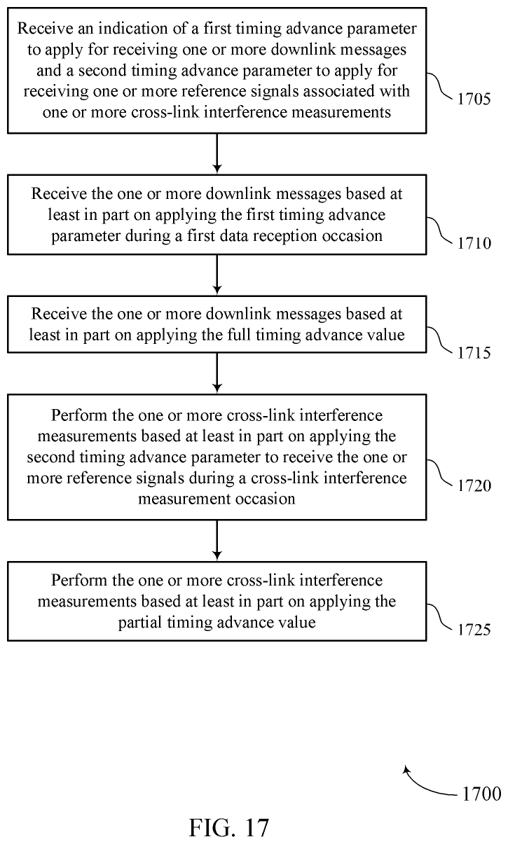

FIG. 17 shows a flowchart illustrating a method 1700 that supports CLI timing alignment for partial TA in accordance with one or more aspects of the present disclosure. The operations of the method 1700 may be implemented by a UE or its components as described herein. For example, the operations of the method 1700 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1705, the method may include receiving an indication of a first TA parameter to apply for receiving one or more downlink messages and a second TA parameter to apply for receiving one or more reference signals associated with one or more CLI measurements. The operations of 1705 may be performed in accordance with examples as disclosed herein. In some examples, aspects of the operations of 1705 may be performed by a TA receiving component 925 as described with reference to FIG. 9.

At 1710, the method may include receiving the one or more downlink messages based on applying the first TA parameter during a first data reception occasion. The operations of 1710 may be performed in accordance with examples as disclosed herein. In some examples, aspects of the operations of 1710 may be performed by a data reception component 930 as described with reference to FIG. 9.

At 1715, the method may include receiving the one or more downlink messages based on applying the full TA value. The operations of 1715 may be performed in accordance with examples as disclosed herein. In some examples, aspects of the operations of 1715 may be performed by a data reception component 930 as described with reference to FIG. 9.

At 1720, the method may include performing the one or more CLI measurements based on applying the second TA parameter to receive the one or more reference signals during a CLI measurement occasion. The operations of 1720 may be performed in accordance with examples as disclosed herein. In some examples, aspects of the operations of 1720 may be performed by a CLI measurement component 935 as described with reference to FIG. 9.

At 1725, the method may include performing the one or more CLI measurements based on applying the partial TA value. The operations of 1725 may be performed in accordance with examples as disclosed herein. In some examples, aspects of the operations of 1725 may be performed by a CLI measurement component 935 as described with reference to FIG. 9.

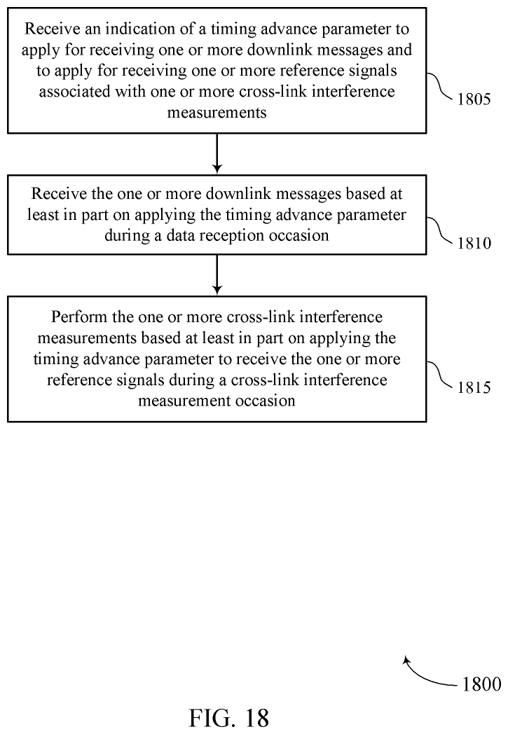

FIG. 18 shows a flowchart illustrating a method 1800 that supports CLI timing alignment for partial TA in accordance with one or more aspects of the present disclosure. The operations of the method 1800 may be implemented by a UE or its components as described herein. For example, the operations of the method 1800 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1805, the method may include receiving an indication of a TA parameter to apply for receiving one or more downlink messages and to apply for receiving one or more reference signals associated with one or more CLI measurements. The operations of 1805 may be performed in accordance with examples as disclosed herein. In some examples, aspects of the operations of 1805 may be performed by a TA receiving component 925 as described with reference to FIG. 9.

At 1810, the method may include receiving the one or more downlink messages based on applying the TA parameter during a data reception occasion. The operations of 1810 may be performed in accordance with examples as disclosed herein. In some examples, aspects of the operations of 1810 may be performed by a data reception component 930 as described with reference to FIG. 9.

At 1815, the method may include performing the one or more CLI measurements based on applying the TA parameter to receive the one or more reference signals during a CLI measurement occasion. The operations of 1815 may be performed in accordance with examples as disclosed herein. In some examples, aspects of the operations of 1815 may be performed by a CLI measurement component 935 as described with reference to FIG. 9.

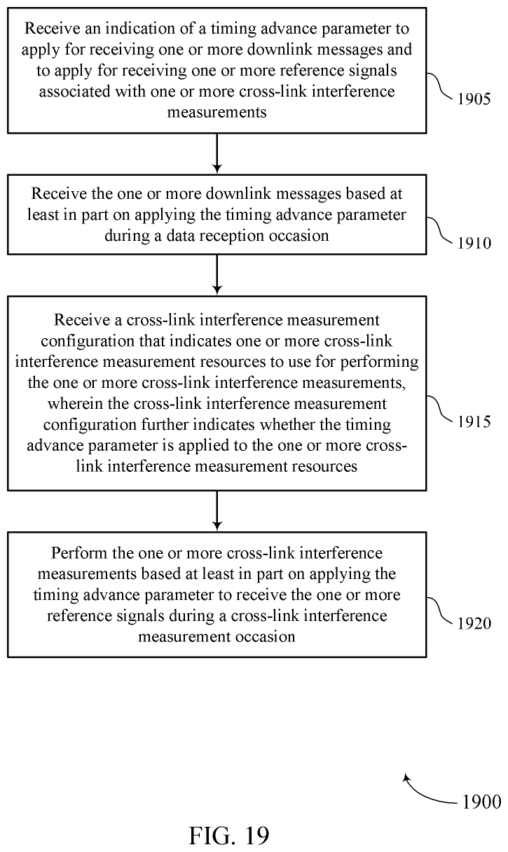

FIG. 19 shows a flowchart illustrating a method 1900 that supports CLI timing alignment for partial TA in accordance with one or more aspects of the present disclosure. The operations of the method 1900 may be implemented by a UE or its components as described herein. For example, the operations of the method 1900 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1905, the method may include receiving an indication of a TA parameter to apply for receiving one or more downlink messages and to apply for receiving one or more reference signals associated with one or more CLI measurements. The operations of 1905 may be performed in accordance with examples as disclosed herein. In some examples, aspects of the operations of 1905 may be performed by a TA receiving component 925 as described with reference to FIG. 9.

At 1910, the method may include receiving the one or more downlink messages based on applying the TA parameter during a data reception occasion. The operations of 1910 may be performed in accordance with examples as disclosed herein. In some examples, aspects of the operations of 1910 may be performed by a data reception component 930 as described with reference to FIG. 9.

At 1915, the method may include receiving a CLI measurement configuration that indicates one or more CLI measurement resources to use for performing the one or more CLI measurements, where the CLI measurement configuration further indicates whether the TA parameter is applied to the one or more CLI measurement resources. The operations of 1915 may be performed in accordance with examples as disclosed herein. In some examples, aspects of the operations of 1915 may be performed by a CLI measurement configuration component 955 as described with reference to FIG. 9.

At 1920, the method may include performing the one or more CLI measurements based on applying the TA parameter to receive the one or more reference signals during a CLI measurement occasion. The operations of 1920 may be performed in accordance with examples as disclosed herein. In some examples, aspects of the operations of 1920 may be performed by a CLI measurement component 935 as described with reference to FIG. 9.

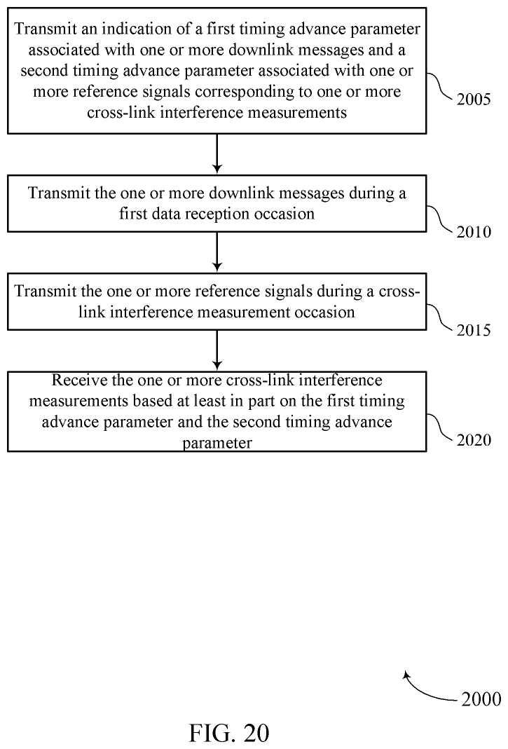

FIG. 20 shows a flowchart illustrating a method 2000 that supports CLI timing alignment for partial TA in accordance with one or more aspects of the present disclosure. The operations of the method 2000 may be implemented by a network entity or its components as described herein. For example, the operations of the method 2000 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 2005, the method may include transmitting an indication of a first TA parameter associated with one or more downlink messages and a second TA parameter associated with one or more reference signals corresponding to one or more CLI measurements. The operations of 2005 may be performed in accordance with examples as disclosed herein. In some examples, aspects of the operations of 2005 may be performed by a TA transmission component 1325 as described with reference to FIG. 13.

At 2010, the method may include transmitting the one or more downlink messages during a first data reception occasion. The operations of 2010 may be performed in accordance with examples as disclosed herein. In some examples, aspects of the operations of 2010 may be performed by a downlink data transmission component 1330 as described with reference to FIG. 13.

At 2015, the method may include transmitting the one or more reference signals during a CLI measurement occasion. The operations of 2015 may be performed in accordance with examples as disclosed herein. In some examples, aspects of the operations of 2015 may be performed by a reference signal transmission component 1335 as described with reference to FIG. 13.

At 2020, the method may include receiving the one or more CLI measurements based on the first TA parameter and the second TA parameter. The operations of 2020 may be performed in accordance with examples as disclosed herein. In some examples, aspects of the operations of 2020 may be performed by a CLI measurement reception component 1340 as described with reference to FIG. 13.

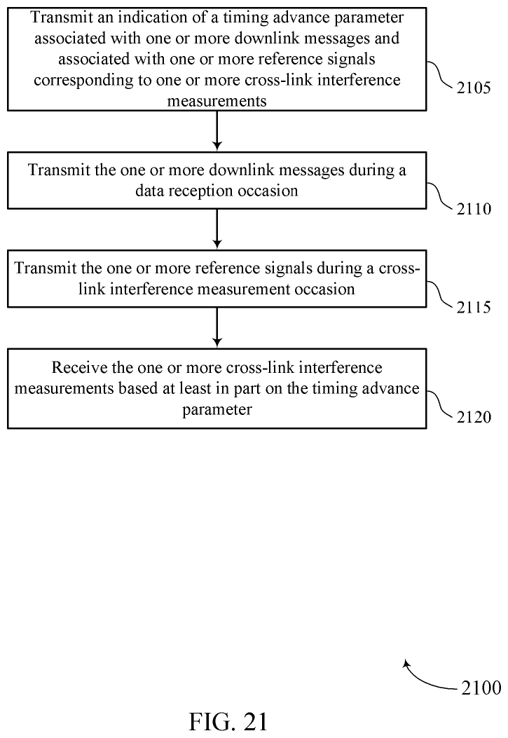

FIG. 21 shows a flowchart illustrating a method 2100 that supports CLI timing alignment for partial TA in accordance with one or more aspects of the present disclosure. The operations of the method 2100 may be implemented by a network entity or its components as described herein. For example, the operations of the method 2100 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 2105, the method may include transmitting an indication of a TA parameter associated with one or more downlink messages and associated with one or more reference signals corresponding to one or more CLI measurements. The operations of 2105 may be performed in accordance with examples as disclosed herein. In some examples, aspects of the operations of 2105 may be performed by a TA transmission component 1325 as described with reference to FIG. 13.

At 2110, the method may include transmitting the one or more downlink messages during a data reception occasion. The operations of 2110 may be performed in accordance with examples as disclosed herein. In some examples, aspects of the operations of 2110 may be performed by a downlink data transmission component 1330 as described with reference to FIG. 13.

At 2115, the method may include transmitting the one or more reference signals during a CLI measurement occasion. The operations of 2115 may be performed in accordance with examples as disclosed herein. In some examples, aspects of the operations of 2115 may be performed by a reference signal transmission component 1335 as described with reference to FIG. 13.

At 2120, the method may include receiving the one or more CLI measurements based on the TA parameter. The operations of 2120 may be performed in accordance with examples as disclosed herein. In some examples, aspects of the operations of 2120 may be performed by a CLI measurement reception component 1340 as described with reference to FIG. 13.

The following provides an overview of aspects of the present disclosure:

Aspect 1: A method for wireless communication at a wireless device, comprising: receiving an indication of a first TA parameter to apply for receiving one or more downlink messages and a second TA parameter to apply for receiving one or more reference signals associated with one or more CLI measurements; receiving the one or more downlink messages based at least in part on applying the first TA parameter during a first data reception occasion; and performing the one or more CLI measurements based at least in part on applying the second TA parameter to receive the one or more reference signals during a CLI measurement occasion.

Aspect 2: The method of aspect 1, wherein the first TA parameter is associated with a first TA coefficient and the second TA parameter is associated with a second TA coefficient, the method further comprising: switching between applying the first TA coefficient to the first TA parameter during the first data reception occasion and the second TA coefficient to the second TA parameter during the CLI measurement occasion.

Aspect 3: The method of aspect 2, further comprising: receiving the one or more downlink messages based at least in part on applying the first TA coefficient; and performing the one or more CLI measurements based at least in part on applying the second TA coefficient, wherein the first TA parameter is different from the second TA parameter based at least in part on the first TA coefficient, the second TA coefficient, or both.

Aspect 4: The method of any of aspects 1 through 3, further comprising: receiving, prior to the CLI measurement occasion, a downlink control message comprising an indication of the second TA parameter; and performing the one or more CLI measurements based at least in part on the indication of the second TA parameter.

Aspect 5: The method of aspect 4, wherein the indication of the second TA parameter instructs the wireless device to switch between applying the first TA parameter during the first data reception occasion and applying the second TA parameter during the CLI measurement occasion.

Aspect 6: The method of any of aspects 4 through 5, wherein the indication of the second TA parameter indicates a value of the first TA parameter, the second TA parameter, or both.

Aspect 7: The method of any of aspects 1 through 6, wherein the first TA parameter comprises a full TA value and the second TA parameter comprises a partial TA value, the method further comprising: receiving the one or more downlink messages based at least in part on applying the full TA value; and performing the one or more CLI measurements based at least in part on applying the partial TA value.

Aspect 8: The method of any of aspects 1 through 7, wherein the second TA parameter is based at least in part on the first TA parameter, and a difference between the first TA parameter and the second TA parameter is less than a threshold timing offset.

Aspect 9: The method of any of aspects 1 through 8, wherein the wireless device comprises a first wireless device and a misalignment occurs between an uplink transmission of a second wireless device and the CLI measurement occasion, the first data reception occasion, or both, the method further comprising: applying the first TA parameter and the second TA parameter based at least in part on prioritizing reception of the one or more downlink messages over performing the one or more CLI measurements.

Aspect 10: The method of any of aspects 1 through 9, wherein the first TA parameter and the second TA parameter comprise full TA parameters, partial TA parameters, or a combination thereof.

Aspect 11: A method for wireless communication at a wireless device, comprising: receiving an indication of a TA parameter to apply for receiving one or more downlink messages and to apply for receiving one or more reference signals associated with one or more CLI measurements; receiving the one or more downlink messages based at least in part on applying the TA parameter during a data reception occasion; and performing the one or more CLI measurements based at least in part on applying the TA parameter to receive the one or more reference signals during a CLI measurement occasion.

Aspect 12: The method of aspect 11, further comprising: receiving the indication of the TA parameter as a downlink control message, the downlink control message indicating a value of the TA parameter.

Aspect 13: The method of any of aspects 11 through 12, further comprising: receiving the indication of the TA parameter, wherein a value of the TA parameter is determined based at least in part on the indication of the TA parameter.

Aspect 14: The method of any of aspects 11 through 13, further comprising: receiving a CLI measurement configuration that indicates one or more CLI measurement resources to use for performing the one or more CLI measurements, wherein the CLI measurement configuration further indicates whether the TA parameter is applied to the one or more CLI measurement resources.

Aspect 15: The method of aspect 14, wherein the TA parameter is associated with a partial TA value or a full TA value.

Aspect 16: The method of any of aspects 11 through 15, further comprising: receiving a CLI measurement configuration that indicates a partial TA value; and applying the TA parameter during the data reception occasion, the CLI measurement occasion, or both, based at least in part on the partial TA value.

Aspect 17: The method of any of aspects 11 through 16, further comprising: receiving a CLI measurement configuration that includes a TA coefficient, wherein the TA coefficient is associated with one or more CLI measurement resources for performing the one or more CLI measurements.

Aspect 18: The method of any of aspects 11 through 17, further comprising: receiving, in a downlink message separate from a CLI measurement configuration, a TA coefficient that is associated with one or more CLI measurement resources for performing the one or more CLI measurements.

Aspect 19: The method of any of aspects 11 through 18, wherein the wireless device comprises a first wireless device, and a value of the TA parameter is associated with a timing difference between the CLI measurement occasion and an uplink transmission of a second wireless device, the method further comprising: applying the value of the TA parameter such that the timing difference between the CLI measurement occasion and the uplink transmission is less than a threshold time difference.

Aspect 20: The method of any of aspects 11 through 19, wherein the wireless device comprises a first wireless device, the method further comprising: receiving an indication of a partial TA coefficient applied by a second wireless device, wherein a value of the TA parameter is based at least in part on application of the partial TA coefficient to the TA parameter.

Aspect 21: The method of any of aspects 11 through 20, the wireless device comprises a first wireless device and wherein the TA parameter is based at least in part on a second TA parameter associated with a second wireless device, and a difference between the TA parameter and the second TA parameter is less than a threshold timing offset.

Aspect 22: The method of any of aspects 11 through 21, wherein the wireless device comprises a first wireless device and the method further comprises: switching from a full-duplex mode to a half-duplex mode based at least in part on a determined misalignment between the CLI measurement occasion and a corresponding uplink transmission of a second wireless device; and performing the one or more CLI measurements based at least in part on applying the TA parameter and switching from the full-duplex mode to the half-duplex mode.

Aspect 23: The method of any of aspects 11 through 22, wherein the wireless device comprises a first wireless device and a misalignment occurs between an uplink transmission of a second wireless device and the CLI measurement occasion, the data reception occasion, or both, the method further comprising: applying the TA parameter based at least in part on prioritizing reception of the one or more downlink messages over performing the one or more CLI measurements.

Aspect 24: The method of any of aspects 11 through 23, wherein the TA parameter comprises a full TA parameter or a partial TA parameters.

Aspect 25: A method for wireless communication at a network entity, comprising: transmitting an indication of a first TA parameter associated with one or more downlink messages and a second TA parameter associated with one or more reference signals corresponding to one or more CLI measurements; transmitting the one or more downlink messages during a first data reception occasion; transmitting the one or more reference signals during a CLI measurement occasion; and receiving the one or more CLI measurements based at least in part on the first TA parameter and the second TA parameter.

Aspect 26: The method of aspect 25, further comprising: transmitting, prior to the CLI measurement occasion, a downlink control message comprising an indication of the second TA parameter; and receiving the one or more CLI measurements based at least in part on the indication of the second TA parameter.

Aspect 27: The method of any of aspects 25 through 26, wherein the first TA parameter comprises a full TA value and the second TA parameter comprises a partial TA value, the method further comprising: transmitting the one or more downlink messages based at least in part on the full TA value; and receiving the one or more CLI measurements based at least in part on the partial TA value.

Aspect 28: A method for wireless communication at a network entity, comprising: transmitting an indication of a TA parameter associated with one or more downlink messages and associated with one or more reference signals corresponding to one or more CLI measurements; transmitting the one or more downlink messages during a data reception occasion; transmitting the one or more reference signals during a CLI measurement occasion; and receiving the one or more CLI measurements based at least in part on the TA parameter.

Aspect 29: The method of aspect 28, further comprising: transmitting a downlink control message comprising an indication of a value of the TA parameter.

Aspect 30: The method of any of aspects 28 through 29, further comprising: transmitting a CLI measurement configuration that indicates one or more CLI measurement resources corresponding to the one or more CLI measurements, wherein the CLI measurement configuration further indicates whether the TA parameter is applied to the one or more CLI measurement resources.

Aspect 31: An apparatus for wireless communication at a wireless device, comprising a processor; memory coupled with the processor; and instructions stored in the memory and executable by the processor to cause the apparatus to perform a method of any of aspects 1 through 10.

Aspect 32: An apparatus for wireless communication at a wireless device, comprising at least one means for performing a method of any of aspects 1 through 10.

Aspect 33: A non-transitory computer-readable medium storing code for wireless communication at a wireless device, the code comprising instructions executable by a processor to perform a method of any of aspects 1 through 10.

Aspect 34: An apparatus for wireless communication at a wireless device, comprising a processor; memory coupled with the processor; and instructions stored in the memory and executable by the processor to cause the apparatus to perform a method of any of aspects 11 through 24.

Aspect 35: An apparatus for wireless communication at a wireless device, comprising at least one means for performing a method of any of aspects 11 through 24.

Aspect 36: A non-transitory computer-readable medium storing code for wireless communication at a wireless device, the code comprising instructions executable by a processor to perform a method of any of aspects 11 through 24.

Aspect 37: An apparatus for wireless communication at a network entity, comprising a processor; memory coupled with the processor; and instructions stored in the memory and executable by the processor to cause the apparatus to perform a method of any of aspects 25 through 27.

Aspect 38: An apparatus for wireless communication at a network entity, comprising at least one means for performing a method of any of aspects 25 through 27.

Aspect 39: A non-transitory computer-readable medium storing code for wireless communication at a network entity, the code comprising instructions executable by a processor to perform a method of any of aspects 25 through 27.

Aspect 40: An apparatus for wireless communication at a network entity, comprising a processor; memory coupled with the processor; and instructions stored in the memory and executable by the processor to cause the apparatus to perform a method of any of aspects 28 through 30.

Aspect 41: An apparatus for wireless communication at a network entity, comprising at least one means for performing a method of any of aspects 28 through 30.

Aspect 42: A non-transitory computer-readable medium storing code for wireless communication at a network entity, the code comprising instructions executable by a processor to perform a method of any of aspects 28 through 30.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method for wireless communication at a wireless device, comprising:
receiving an indication of a first timing advance parameter to apply for receiving one or more downlink messages and a second timing advance parameter to apply for receiving one or more reference signals associated with one or more cross-link interference measurements;
receiving the one or more downlink messages based at least in part on applying the first timing advance parameter during a first data reception occasion; and
performing the one or more cross-link interference measurements based at least in part on applying the second timing advance parameter to receive the one or more reference signals during a cross-link interference measurement occasion.

2. The method of claim 1, wherein the first timing advance parameter is associated with a first timing advance coefficient and the second timing advance parameter is associated with a second timing advance coefficient, the method further comprising:
switching between applying the first timing advance coefficient to the first timing advance parameter during the first data reception occasion and the second timing advance coefficient to the second timing advance parameter during the cross-link interference measurement occasion.

3. The method of claim 2, further comprising:
receiving the one or more downlink messages based at least in part on applying the first timing advance coefficient; and
performing the one or more cross-link interference measurements based at least in part on applying the second timing advance coefficient, wherein the first timing advance parameter is different from the second timing advance parameter based at least in part on the first timing advance coefficient, the second timing advance coefficient, or both.

4. The method of claim 1, further comprising:
receiving, prior to the cross-link interference measurement occasion, a downlink control message comprising an indication of the second timing advance parameter; and
performing the one or more cross-link interference measurements based at least in part on the indication of the second timing advance parameter.

5. The method of claim 4, wherein the indication of the second timing advance parameter instructs the wireless device to switch between applying the first timing advance parameter during the first data reception occasion and applying the second timing advance parameter during the cross-link interference measurement occasion.

6. The method of claim 4, wherein the indication of the second timing advance parameter indicates a value of the first timing advance parameter, the second timing advance parameter, or both.

7. The method of claim 1, wherein the first timing advance parameter comprises a full timing advance value and the second timing advance parameter comprises a partial timing advance value, the method further comprising:
receiving the one or more downlink messages based at least in part on applying the full timing advance value; and
performing the one or more cross-link interference measurements based at least in part on applying the partial timing advance value.

8. The method of claim 1, wherein the second timing advance parameter is based at least in part on the first timing advance parameter, and a difference between the first timing advance parameter and the second timing advance parameter is less than a threshold timing offset.

9. The method of claim 1, wherein the wireless device comprises a first wireless device and a misalignment occurs between an uplink transmission of a second wireless device and the cross-link interference measurement occasion, the first data reception occasion, or both, the method further comprising:
applying the first timing advance parameter and the second timing advance parameter based at least in part on prioritizing reception of the one or more downlink messages over performing the one or more cross-link interference measurements.

10. The method of claim 1, wherein the first timing advance parameter and the second timing advance parameter comprise full timing advance parameters, partial timing advance parameters, or a combination thereof.

11. A method for wireless communication at a wireless device, comprising:
receiving an indication of a timing advance parameter to apply for receiving one or more downlink messages and to apply for receiving one or more reference signals associated with one or more cross-link interference measurements;
receiving the one or more downlink messages based at least in part on applying the timing advance parameter during a data reception occasion; and
performing the one or more cross-link interference measurements based at least in part on applying the timing advance parameter to receive the one or more reference signals during a cross-link interference measurement occasion.

12. The method of claim 11, further comprising:
receiving the indication of the timing advance parameter as a downlink control message, the downlink control message indicating a value of the timing advance parameter.

13. The method of claim 11, further comprising:
receiving the indication of the timing advance parameter, wherein a value of the timing advance parameter is determined based at least in part on the indication of the timing advance parameter.

14. The method of claim 11, further comprising:
receiving a cross-link interference measurement configuration that indicates one or more cross-link interference measurement resources to use for performing the one or more cross-link interference measurements, wherein the cross-link interference measurement configuration further indicates whether the timing advance parameter is applied to the one or more cross-link interference measurement resources.

15. The method of claim 14, wherein the timing advance parameter is associated with a partial timing advance value or a full timing advance value.

16. The method of claim 11, further comprising:
receiving a cross-link interference measurement configuration that indicates a partial timing advance value; and
applying the timing advance parameter during the data reception occasion, the cross-link interference measurement occasion, or both, based at least in part on the partial timing advance value.

17. The method of claim 11, further comprising:
receiving a cross-link interference measurement configuration that includes a timing advance coefficient, wherein the timing advance coefficient is associated with one or more cross-link interference measurement resources for performing the one or more cross-link interference measurements.

18. The method of claim 11, further comprising:
receiving, in a downlink message separate from a cross-link interference measurement configuration, a timing advance coefficient that is associated with one or more cross-link interference measurement resources for performing the one or more cross-link interference measurements.

19. The method of claim 11, wherein the wireless device comprises a first wireless device and a value of the timing advance parameter is associated with a timing difference between the cross-link interference measurement occasion and an uplink transmission of a second wireless device, the method further comprising:
applying the value of the timing advance parameter such that the timing difference between the cross-link interference measurement occasion and the uplink transmission is less than a threshold time difference.

20. The method of claim 11, wherein the wireless device comprises a first wireless device, the method further comprising:
receiving an indication of a partial timing advance coefficient applied by a second wireless device, wherein a value of the timing advance parameter is based at least in part on application of the partial timing advance coefficient to the timing advance parameter.

21-30. (canceled)
